(19) United States
(12) Patent Application Publication
(10) Pub. No.: US 2001/0011981 A1
(43) Pub. Date: Aug. 9, 2001

(54) Active matrix addressed liquid crystal display device

(76) Inventors: Tsunenori Yamamoto, Hitachi-shi (JP); Makoto Tsumura, Hitachi-shi (JP); Ritsuo Fukaya, Hitachinaka-shi (JP); Tsutomu Furuhashi, Yokohama-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/834,876

(22) Filed: Apr. 16, 2001

Related U.S. Application Data
(63) Continuation of application No. 08/997,747, filed on Dec. 24, 1997.
Application No. 08/997,747 is a continuation-in-part of application No. 08/955,365, filed on Oct. 21, 1997.

(30) Foreign Application Priority Data
Dec. 27, 1996 (JP) 8-349302

(51) Int. Cl. G09G 3/36

(52) U.S. Cl. 345/87

(57) ABSTRACT

In order to eliminate cross talk and horizontal brightness variation and improve the display quality and aperture ratio in an active matrix-addressed liquid crystal display in which an electrical field is produced generally in parallel to its substrate, the load on the common electrodes or scanning lines is reduced. Respective pixels aligned in the direction of any scanning line selectably applied to which a scanning signal is caused to change their optical properties alternately for juxtaposed pixels. On the other hand, in a plurality of pixels defined in a plurality of areas surrounded by a plurality of signal lines and a plurality of scanning lines, respective pixels which are juxtaposed in the direction of the scanning line are arranged to form a storage capacitance respectively between its pixel electrode and a common line or scanning line corresponding thereto, which is different between juxtaposed pixels.

### CROSS-REFERENCE TO RELATED APPLICATION

This application is a continuation of U.S. application Ser. No. 09/997,747, filed Dec. 24, 1997, which is a continuation-in-part of our prior U.S. application Ser. No. 08/955,365, filed Oct. 21, 1997, the subject matter of which is incorporated herein by reference.

### BACKGROUND OF THE INVENTION

The present invention relates to a liquid crystal display device having an active matrix addressed liquid crystal panel which features a high quality image display, which is free from cross talk and horizontal brightness variation, and which has a high aperture ratio.

An active matrix addressed liquid crystal display device, which is thin and light-weight and features a high precision picture quality comparable to a cathode ray tube, is now beginning to be widely used as a display terminal for office automation equipment. There are two basic types of such an active matrix liquid crystal display device, one of which uses counterposed transparent electrodes formed on the opposed surface of two substrates as drive electrodes for driving the liquid crystal layer, which is disposed therebetween, and the other of which features a reduced load capacitance and a wider viewing angle than the transparent electrode type device.

The second type of device, which features a more reduced load capacitance and a wider viewing angle, is comprised of two electrodes in interdigital arrangement on the same substrate for applying an electrical field to the liquid crystal layer approximately in a parallel direction relative to the face of the substrate. An example of such devices is disclosed, for example, in JP Publication No. 63-21907 and JP-A Laid Open No. 7-36058. In these prior publications, it is indicated that in order to reduce the load capacitance between scanning lines, signal lines and counter electrodes, an interdigital arrangement is provided within the pixel, and counter electrodes (common lines) are formed on the same substrate with other wirings, and preferably in parallel with the scanning lines. Further, a structure combining scanning lines and common lines in a one-to-one or two-to-one relationship is described. Still further, another structure in which scanning lines are used also as common lines is described.

However, in these prior structures, respective counter electrodes of respective pixels in a group of pixels addressed by one scanning line are connected to one and the same scanning line (or common line) which is different from the addressing scanning line. In such an arrangement, however, there is a problem in that distortion occurs in the waveforms of signals on the scanning lines or common lines to which the counter electrodes are connected when each signal voltage is charged in each pixel during a selected scanning period, or when the potential of the scanning line is changing after completion of the selected scanning period. In particular, in the manufacture of a large-sized liquid crystal display, or for achieving a high resolution, a problem of deterioration in the image quality due to horizontal cross talk or horizontal brightness variation becomes remarkable and substantial.

Further, the pixel structure of the prior publications inherently has a large non-transmittance area occupied by its scanning lines, common lines, pixel electrodes, counter electrodes and the like, thereby tending to limit its aperture ratio even more in larger sized and higher resolution display devices. Still further, when the size of scanning lines and common lines is increased in order to reduce the above-mentioned distortion of the signal waveforms, the resulting aperture ratio will become significantly small.

### SUMMARY OF THE INVENTION

The present invention has been contemplated to solve all of the above-mentioned problems which are associated with the prior art simultaneously.

Namely, an object of the present invention is to provide an active matrix addressed liquid crystal display device which features a high quality image display which is free from cross talk and horizontal brightness variation.

Another object of the invention is to provide an active matrix addressed liquid crystal display device which features a high aperture ratio which is realized by reducing wiring width even in a high resolution display.

The above-mentioned objects of the invention can be accomplished by halving the number of pixels (areas surrounded by signal lines and scanning lines) to be driven by a single common electrode line. More particularly, at a first timing, a first group of alternate pixels aligned on a first scanning line are displayed, so that every other pixel on the first scanning line is displayed, and also a second group of alternate pixels aligned on a second scanning line are displayed, so that every other pixel on the second scanning line is displayed, with the respective pixels displayed on the first and the second scanning lines forming a staggered display pattern. Then, at a second timing, the remaining pixels which were not displayed with the second group of pixels aligned on the second scanning line are displayed along with a third group of alternate pixels aligned on a third scanning line, so that every other pixel on the third scanning line is displayed, with the respective pixels of the second group of pixels on the second scanning line and the respective pixels of the third group of pixels on the third scanning line forming another staggered pattern. This scanning process is continued until all pixels on the scanning lines have been displayed. Thereby, as a whole, pixels on the display are charged in staggered patterns of every other pixel alternately to form an overall staggered pattern.

In the case of an arrangement where common lines are provided, since each pixel electrode of respective pixels juxtaposed in the direction of a scanning line is wired to form each storage capacitance with a different common line, the load concurrently imposed on one scanning line or common line is halved, thereby effectively reducing distortion in the signal waveforms, thus reducing cross talk and horizontal brightness variation. Further, because of the reduced load on the common lines, the width of the common lines can be narrowed.

More specifically, the following structures are contemplated for accomplishing the objects of the invention.

(1) A structure in which a counter electrode, in any one of respective pixels juxtaposed in the direction of a scanning line, produces an electric field with each pixel electrode therein and is connected to a scanning line (or common line, if available) corresponding thereto which is different from each other between juxtaposed pixels.

(2) A structure in which each active matrix element connected to each pixel electrode of respective pixels juxtaposed in the direction of the scanning line is connected to a scanning line corresponding thereto, which is different from each other between juxtaposed pixels.

(3) A structure in which a storage capacitance is formed between one of the pixel electrodes of respective pixels juxtaposed in the direction of the scanning line and a counter electrode connected to another scanning line, another common line or another wiring different from the scanning or common line corresponding thereto.

(4) A structure in which respective counter electrodes of respective pixels juxtaposed in the direction of a signal line are connected to respectively different common lines corresponding thereto, which are different from one another, between juxtaposed pixels, such that respective pixels undergoing changes of transmittance are arranged in a staggered pattern along a scanning line, thereby reducing the load imposed on the common lines, and hence preventing the occurrence of cross talk.

The following drive methods can be contemplated as a means for applying voltages to the above-mentioned electrodes.

(1) As a first drive method for applying a voltage to respective lines and electrodes, it is contemplated to apply a non-select voltage during a non-selected period and apply a select voltage during a selected period to each scanning line, then to apply a signal voltage to each signal line by reversing the polarity of its voltage alternately for every line and at every frame writing cycle, and to apply a common voltage to each common line by reversing the polarity of its voltage alternately for every line and at every frame writing cycle.

(2) As a second drive method for applying a voltage to respective lines and electrodes, it is contemplated to apply a non-select voltage, which has binary values (high and low), during a non-selected period, and to apply a select voltage, which has one value during a selected period, to each scanning line, then to apply a signal voltage to each signal line by reversing the polarity of its voltage alternately for every line and at every frame writing cycle, and to apply a common voltage to each common line by reversing the polarity of its voltage for every line and at every frame writing cycle.

(3) As a third drive method for applying a respective voltage to respective lines and electrodes, it is contemplated to apply a non-select voltage during a non-select period and apply a select-voltage during a selected period to each scanning line, to apply a voltage to each pixel by reversing the polarity of its voltage and to apply a common voltage to each common line by reversing the polarity of its voltage alternately for every line and at every frame writing cycle, and to apply a signal voltage to each signal line by reversing the polarity of its voltage alternately for every line and at every frame writing cycle.

By application of these voltages according to any one of the above-mentioned drive methods, respective pixels arranged in a staggered pattern, according to the invention, can be driven effectively.

### BRIEF DESCRIPTION OF THE DRAWINGS

These and other objects, features and advantages of the present invention will be understood more clearly from the following detailed description, when taken with reference to the accompanying drawings, wherein:

FIG. 1 is a diagram illustrating the planar structure of pixel members forming a first embodiment of the invention;

FIG. 2 is a cross-section of the pixel members taken along line A-A′ in FIG. 1;

FIG. 3 is a cross-section of the pixel members taken along line B-B′ in FIG. 1;

FIG. 4 is a cross-section of the pixel members taken along line C-C′ in FIG. 1;

FIG. 5 is an equivalent circuit diagram of a liquid crystal panel according to the first embodiment of the invention;

FIG. 6 is a schematic block diagram showing the system configuration of a liquid crystal display unit according to the first embodiment;

FIG. 7 is a diagram showing an example of data array conversion from a normal pixel array to a staggered-pixel array according to the invention;

FIG. 8 is a block diagram of a circuit for executing the data array conversion of the invention;

FIG. 9 is a timing chart for data array conversion according to the invention;

FIG. 10 is a drive voltage waveform diagram for the first embodiment of the invention;

FIG. 11 is a diagram illustrating the planar structure of pixel members according to a second embodiment of the invention;

FIG. 12 is a cross-sectional view of the pixel members taken along line D-D′ in FIG. 11;

FIG. 13 is a diagram illustrating the planar structure of pixel members according to a third embodiment of the invention;

FIG. 14 is a cross-sectional view of the pixel member in part taken along line D-D′ in FIG. 13;

FIG. 15 is a schematic circuit diagram showing an equivalent circuit of a liquid crystal panel according to the third embodiment of the invention;

FIG. 16 is a drive voltage waveform diagram for the third embodiment of the invention;

FIG. 17 is a further drive voltage waveform diagram for the third embodiment of the invention;

FIG. 18 is a diagram which shows the structure of a bottom substrate of an active matrix-addressed liquid crystal display according to a fourth embodiment of the invention;

FIG. 19 shows a cross-sectional view of the bottom substrate structure taken along line F-F′ in FIG. 18;

FIG. 20 shows a cross-sectional view of the bottom substrate structure taken along line G-G′ in FIG. 18;

FIG. 21 is a schematic circuit diagram of equivalent circuit of the bottom substrate structure of FIG. 18:

FIG. 22 is a drive voltage waveform diagram for the fourth embodiment of the invention;

FIG. 23 is a diagram showing the planar structure of pixel members according to a fifth embodiment of the invention;

FIG. 24 is a schematic circuit diagram of an equivalent circuit of a liquid crystal panel according to the fifth embodiment of the invention;

FIG. 25 is a timing diagram showing data array conversion according to the invention;

FIG. 26 is a drive voltage waveform diagram for the fifth embodiment of the invention;

FIG. 27 is a diagram showing the planar structure of pixel members according to a sixth embodiment of the invention;

FIG. 28 is a schematic block diagram of an equivalent circuit of a liquid crystal panel according to the sixth embodiment of the invention; and

FIG. 29 is a drive voltage waveform diagram for the sixth embodiment of the invention.

### DESCRIPTION OF THE PREFERRED EMBODIMENT

FIRST EMBODIMENT:

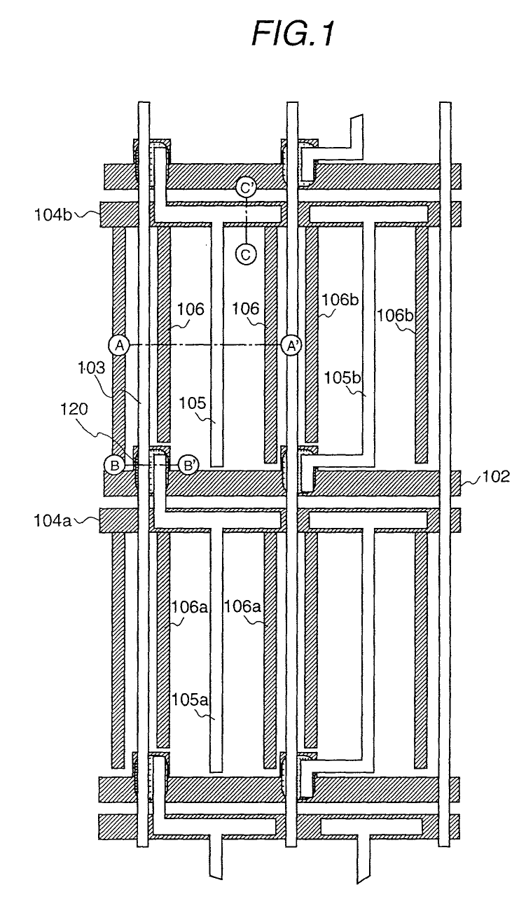

FIG. 1 shows the structure of a substrate having TFTs thereon in an active matrix-addressed liquid crystal display device according to the first embodiment of the invention.

Scanning lines 102 and signal lines 103 are disposed in a matrix arrangement, and a thin film transistor 120 is formed at each intersection therebetween, having the respective lines as two of its terminals. Thin film transistor 120 is provided with another terminal which is connected to a pixel electrode 105, which functions as a switch to apply a voltage between the pixel electrode 105 and a counter electrode 106. Counter electrode 106 is connected to a common line 104, which is arranged in parallel with scanning line 102.

Respective pixel electrodes 105, connected to the same scanning line 102 via respective thin film transistors 120 disposed thereon, are arranged in a staggered pattern along its scanning line 102 alternately in the upper and lower directions thereof for every other pixel along the scanning line. For example, in FIG. 1, a first pixel electrode 105a is disposed in the downward direction from scanning line 102, while a second pixel electrode 105b is disposed in the upward direction from the scanning line 102. In this arrangement, a counter electrode 106a corresponding to pixel electrode 105a is connected to a common line 104a, and a counter electrode 106b corresponding to pixel electrode 105b is connected to another common line 104b.

In such wiring arrangements, according to the invention, when a scanning line 102 is selected and display data are written into a group of pixels connected to this scanning line 102, this group of pixels which have been written or charged with display data are not aligned linearly, but are disposed in a staggered pattern up and down for every other pixel on either side of the scanning line. Further, since a current which flows through the common line for applying a voltage to the counter electrodes is divided into two subcurrents: one flowing through common line 104a and the other flowing through common line 104b, the load imposed on the common line 104 can be halved, so that the voltage distortion thereof can be reduced substantially, thereby reducing horizontal cross modulation and horizontal brightness variation substantially. Still further, the fact that the load on the common line is halved means that the common line can be fabricated so as to be thinner even though its electrical resistance may increase, without causing any deterioration in the display quality. Thereby, by provision of thinner common lines, the aperture ratio of the liquid crystal display can be improved substantially.

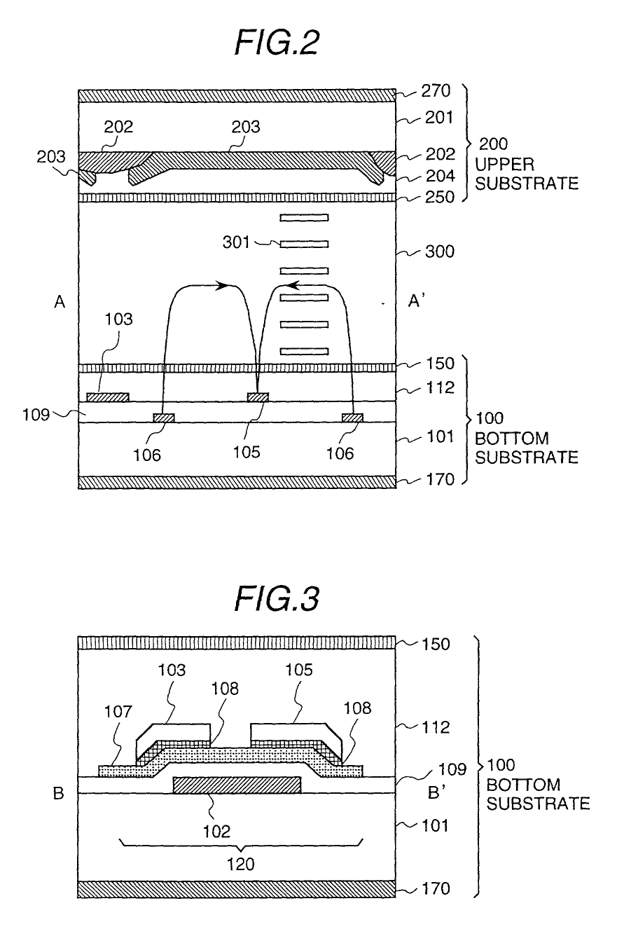

FIG. 2 shows a cross-sectional view of the liquid crystal panel of this embodiment taken along line A-A′ of FIG. 1. A bottom substrate 100 and an upper substrate 200 respectively comprise transparent glass plates 101, 201 which are 0.7 mm thick and have a polished surface. Bottom substrate 100 has signal line 103, pixel electrode 105 and counter electrode 106, as indicated in FIG. 1, and the bottom substrate 100 further has a SiN layer 109 which isolates these electrodes, and a passivation layer 112 for protection of the wiring.

Further, the other glass plate 201 has a low conductivity shading layer (black matrix) 202, which is formed to prevent light from leaking from a gap around an area 203 corresponding to an area in the bottom substrate 100 surrounded by pixel electrode 105 and counter electrode 106, and a three-primary color (R,B,G) filter 203 formed in a stripe shape on the shading layer. Further, a planarization transparent polymer layer 204 is laminated on the color filter for planarization of its surface.

Alignment films 150, 250 are formed on an innermost surface of these two substrates, respectively, and are subjected to rubbing treatment, then a liquid crystal composition 300 is filled in between these substrates. Further, outermost surfaces of these substrates are sandwiched by two polarizers 170 and 270 to form the liquid crystal display panel of the invention. Polyimide is used as the alignment films in this embodiment of the invention. The directions of rubbing of the alignment films in the upper and the lower interfaces are set approximately parallel with each other, the angle of which is set at 85 degrees relative to the direction of the applied electrical field.

The gap between the upper and the lower substrates is supported by spherical polymer beads (not shown) which are dispersed at the periphery between these substrates, and the gap is set at 4.5 μm with the liquid crystal composition filled in. The liquid crystal composition 300 is a nematic liquid crystal composition which has a positive anisotropy of dielectric constant Δε, the value of which is 7.3 (at 1 kHz), and an anisotropy of reflectance indices Δn, the value of which is 0.072 (589 nm, 20° C.). Thereby, Δn·d=0.324 μm.

Of the two polarizers, the transmission axis of one polarizer is disposed substantially in parallel with the direction of rubbing of its associated alignment film (at 85 deg. relative to the direction of the applied electric field), and the transmission axis of the other polarizer is disposed substantially orthogonal to the direction of rubbing of its associated alignment film (−5 deg. relative to the direction of the applied electric field).

By such arrangements, when a voltage is applied across pixel electrode 105 and counter electrode 106, a normally close property is obtained in which a pixel becomes dark at a low voltage and bright at a high voltage. The intensity of light transmitted is modulated by producing an electric field E across the pixel electrode 105 and counter electrode 106, in parallel with the glass plate 101, thereby controlling the orientation of liquid crystal molecules 301 in liquid crystal composition 300.

FIG. 3 shows a cross-sectional view in part of the bottom substrate 100 taken along line B-B′ in FIG. 1. This cross-sectional view indicates also a cross-section of a thin film transistor (TFT) 120 which is comprised of a pixel electrode (source electrode) 105, a signal electrode (drain electrode) 103, a scanning electrode (gate electrode) 102, and a-Si layer 107 consisting mainly of a-Si. Further, ohmic contact layer 108 comprising n-type a-Si doped with phosphor (S) is formed between a-Si layer 107 and signal line 103 as well as pixel electrode 105 for providing ohmic contact therebetween. An SiN layer 109 is interposed between the a-Si layer 107 and the scanning electrode 102 on the glass plate 101. Finally, a passivation layer 112 is formed on thin film transistor 120. With the inclusion of alignment film 150 formed on the passivation layer 112 and polarizer 170 formed under the glass plate 101, the bottom substrate 100 is defined. In this embodiment of the invention, an inverted staggered-type a-Si thin film transistor (TFT) is used as an active element, however, the invention is not limited thereto, since a staggered-type a-Si TFT, p-Si TFT, or a MOS-type transistor on a silicon wafer may be used as well.

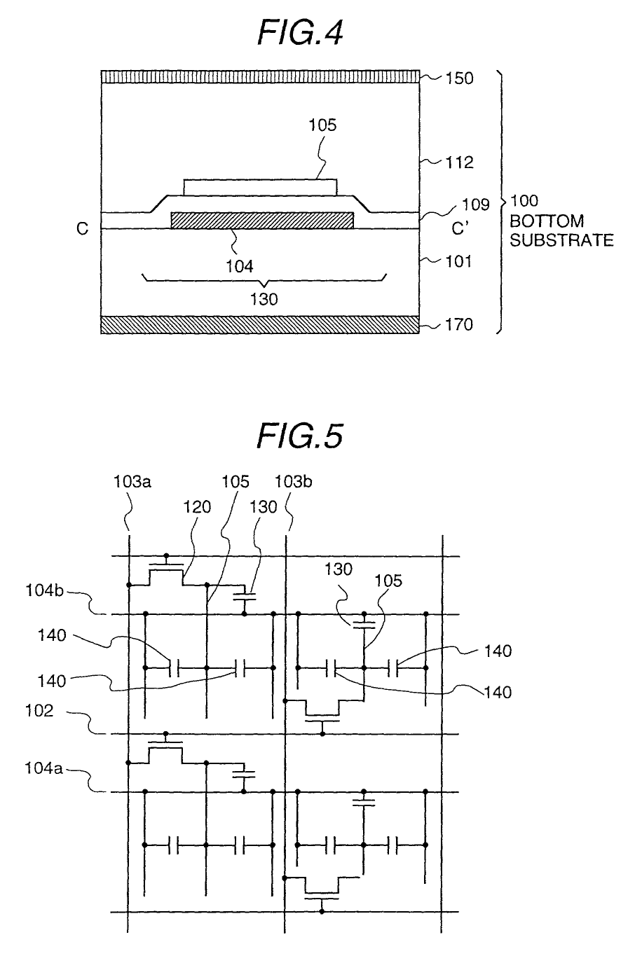

With reference to FIG. 4, a cross-sectional view in part of the bottom substrate 100 taken along line C-C′ of FIG. 1 is shown. This cross-sectional view shown in FIG. 4 represents a cross-section of a storage capacitance 130. Storage capacitance 130 is formed between common line 104 and pixel electrode 105 isolated by SiN layer 109 interposed therebetween. Passivation layer 112 is formed on the storage capacitance, and further the bottom substrate 100 includes alignment film 150 and polarizer 170 as well.

Now, a driving method according to the first embodiment of the invention will be described. FIG. 5 shows an equivalent circuit of a substrate structure having TFTs thereon in the active matrix-addressing liquid crystal display of FIG. 1, according to this embodiment of the invention. Corresponding to one scanning line 102, there are provided two common lines 104a, 104b and two signal lines 103a, 103b associated therewith. In each pixel area surrounded by these scanning lines and signal lines, there are provided a thin film transistor 120, a storage capacitance 130 and a liquid crystal capacitance 140, assuming that each liquid crystal has a capacitance. Here, liquid crystal capacitance 140 and storage capacitance 130 form a parallel capacitance, which substantially makes up the overall capacitance connected to pixel electrode 105.

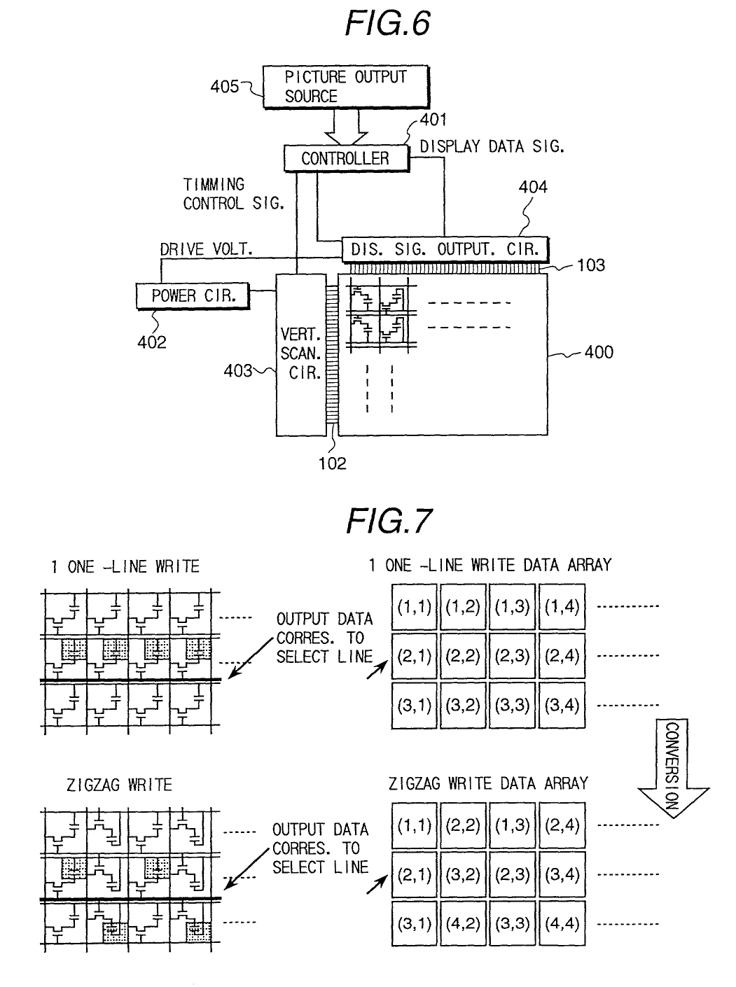

A system configuration of the first embodiment of the invention is indicated in FIG. 6. Display data and display timing control signals output from a picture signal generator 405 are converted by controller 401 to appropriate display data and timing control signals suitable for display on the liquid crystal display device according to this embodiment of the invention. In response to this display data and the timing control signals, and a drive voltage applied from a power supply circuit 402, a display signal output circuit 404 and a vertical scanning circuit 403 generate signal voltages and scanning voltages, respectively, and supply them to liquid crystal display panel 400 via scanning lines 102 and signal lines 103.

By way of example, the display data from picture signal generator 405 is transferred normally as a one-line write sequence. Namely, after display data for each pixel is transferred for one line, the next display data is transferred for a subsequent line. Controller 401 is also provided, which operates to convert a data array of this one-line data transfer sequence to a data array of the staggered data write arrangement of the present invention. FIG. 7 shows a schematic diagram of the data array before conversion and after conversion. This conversion is required for providing a data array having a staggered pattern corresponding to a staggered arrangement of pixels wherein every other pixel is written when its scanning line is selected.

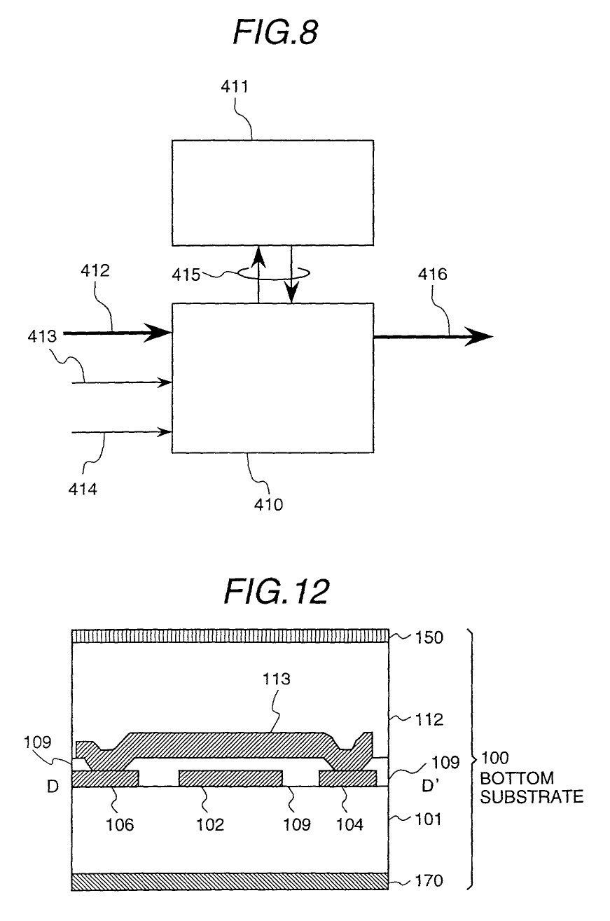

A conversion circuit for executing the above-mentioned data array conversion is shown in FIG. 8. A data array conversion controller 410, which is controlled in response to a one-line data delimit signal 413, received from a picture input/output source provided internally or externally of the liquid crystal display, and a data clock signal 414, transfers a portion of the data signal 412, which also is received from the picture input/output source provided internally or externally of the liquid crystal display and which is to be written at the time of activation of a subsequent scanning line, to a data memory 411 so as to be stored therein. At the same time, the controller reads out a portion of data, which was stored at the time of receipt of the preceding data line, from data memory 411, and outputs it, while combining it with the remaining input data 412, as output data 416 to a pixel display signal output circuit in a matrix for data display.

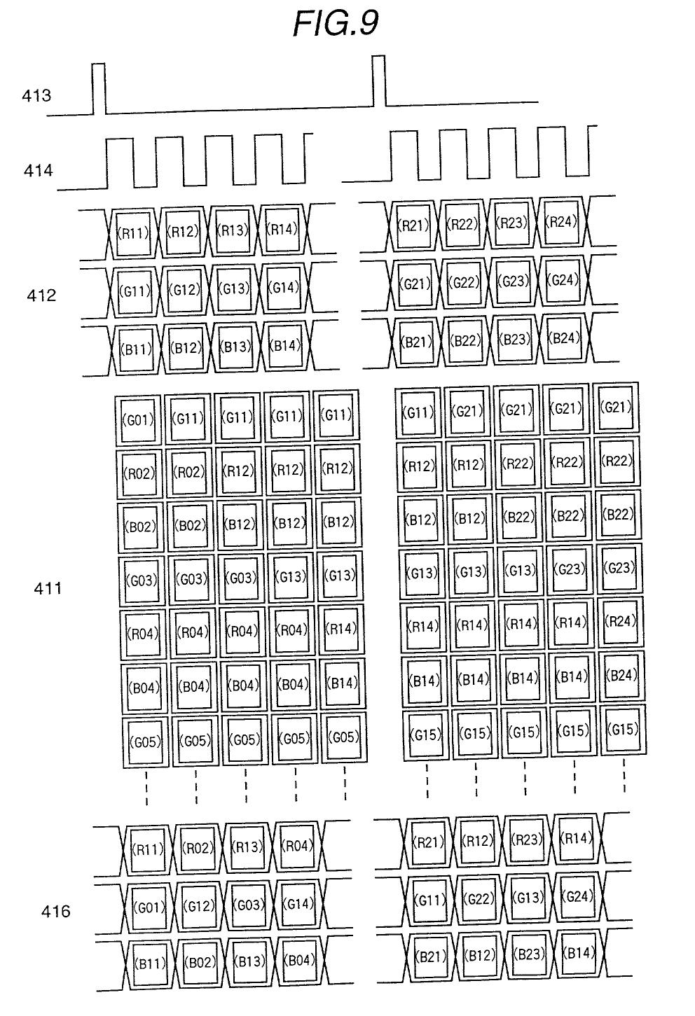

A timing diagram showing the foregoing conversion operation is illustrated in FIG. 9. Input data signal 412 actually consists of three parallel input lines for the colors R-G-B, hence providing a lateral pixel arrangement for the R-G-B colors, thereby requiring respective data conversion for the R-G-B signals. The start of data conversion to effect the interchanging of data portions is triggered by one line data switching signal 413 and is executed at the timing of every received data clock signal 414. In synchronism with a clock signal 414 immediately following one line data switching signal 413, which triggers the data conversion, G signal G11 is taken out from input signal 412 and transferred via memory access line 415 to data memory 411. At the same time, G signal GO1 on the preceding line, which was previously stored in data memory 411, is read out and output in combination with the remaining data signal (R11 and B11) as data output 416. At the next clock signal, R signal R12 and B signal B12 are taken out from input data and stored in the data memory 411, and at the same time a preceding R signal R02 and a preceding B signal B02 of the preceding line are read out from the memory to be combined with a remaining signal G12 in the data output signal 416. Afterwards, at every data clock signal 414, this cycle of store and read-out of the G signal and R+B signals is repeated. Then, when the next one-line data switching signal 413 is input, write and read addresses in the data memory are refreshed to original data addresses to allow data interchange conversion to be continued.

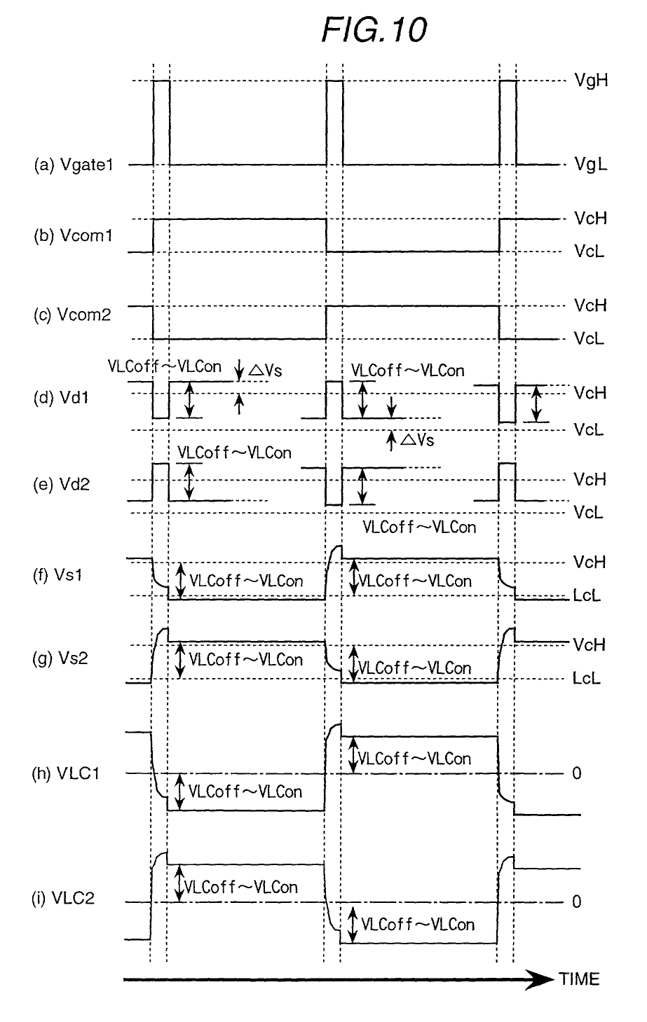

FIG. 10 shows the drive voltage waveforms for this embodiment of the invention. Line (a) indicates a scanning voltage Vgate1 which is applied to a scanning line (for example, scanning line 102 in FIG. 5). Line (b) indicates a common voltage Vcom1 which is applied to a common line (common line 104a in FIG. 5), and line (c) indicates another common voltage Vcom2 which is applied to another common line (common line 104b in FIG. 5) juxtaposed to the common line 104a. Line (d) indicates a signal voltage Vd1 which is applied to a signal line (signal line 103a in FIG. 5) of a pixel connected to the common line to which common voltage Vcom1 is applied. Line (e) indicates a signal voltage Vd2 which is applied to another signal line (signal line 103b in FIG. 5) juxtaposed to the signal line 103a. Further, lines (f) and (g) show pixel electrode voltages Vs1 and Vs2 in respective pixels, which are applied signal voltages Vd1 and Vd2, respectively. Lines (h) and (i) show liquid crystal voltages V_{LC1} and V_{LC2} which are applied across respective liquid crystal layers in respective pixels.

Scanning voltage Vgate1 has a select voltage level VgH and a non-select voltage level VgL, and the period for applying the select voltage is, for example, 25 μs, while the cycle of its application is approximately 16.6 ms. Common voltages Vcom1 and Vcom2 have a common high voltage level VcH and a common low voltage level VcL, and the period for applying each of these voltages is the same as the time of one cycle of Vgate1. Further, the voltages Vcom1 and Vcom2 differ from each other since their phases are inverted. When the scanning voltage Vgate1 is at the select voltage level VgH, signal voltages Vd1 and Vd2 are set at values of Vcom or Vcom2+V_{LC} (the common voltages Vcom1 or Vcom2 are used as a reference voltage) in order to apply liquid crystal application voltage V_{LC} across the liquid crystal layer.

As described above, since liquid crystal application voltage V_{LC} has a normally close characteristic, for example, V_{LCoff}=0V when dark, and V_{LCoff}=12V when white, at the time of half tone display, the values of voltage change therebetween. Further, the term of ±V_{LC} is given for enabling an ac voltage supply to the liquid crystal. For example, when Vcom1=VcH, Vd1 takes a value of VcH-V_{LC}, and when Vcom1=VcL, Vd1 takes a value of VcL+V_{LC}. Further, in consideration of a variation ΔVs of the pixel voltage Vs, which occurs when the TFT changes from the ON-state to the OFF-state, values of Vd1 become VcH-V_{LC}+ΔVs and VcL+V_{LC}+ΔVS. Still further, since Vd1 and Vd2 have a different reference value of Vcom based either on Vcom1 or Vcom2, they are set at values of the liquid crystal application voltage having a reverse polarity. Further, when the next scanning line is selected, since values of Vcom of the reference voltage change, their polarity is caused to reverse also with respect to time.

By application of these signals, immediately after the change of Vgate1 from the select voltage level VgH to the non-select voltage level VgL, the potential of the pixel electrode in each pixel becomes −V_{LC} or +V_{LC} relative to its reference voltage level VcH or VcL, and then its potential is retained for a period of 16.6 ms until Vgate1 assumes the next select voltage level VgH. The actual voltage V_{LC1} or V_{LC2} applied across the liquid crystal layer becomes the difference between its pixel electrode's potential Vs1 or Vs2 and its counter electrode's potential, which is equal to the common line potential Vcom1 or Vcom2. In response to this actual voltage, the liquid crystal modulates light to determine the brightness of its pixel.

Depending on the magnitude of the voltage applied to the signal line, there arises a problem in that the potential of the counter electrode, which is equal to the potential of the common line, changes during retention of the liquid crystal application voltage due to capacitance coupling with the signal line. However, since both the liquid crystal capacitance and the storage capacitance are connected to the common line according to the invention, the liquid crystal voltage V_{LC1} or V_{LC2} will not change even if a redistribution of charges in the pixel occurs. In the prior art, where the above-mentioned two capacitances are connected to different lines, when a voltage of either one of these different lines changes, the quantity of change in the liquid crystal voltage due to redistribution of charges will become substantial, which in consequence causes vertical and horizontal cross modulations and deterioration in the display quality. However, according to this embodiment of the invention, as described above, cross talk and horizontal brightness variation due to a change in the voltage of the common line during retention of the liquid crystal voltage can be eliminated.

In the first embodiment of the invention, as described above, respective counter electrodes in a group of pixels which have been selected by one scanning line are connected alternately to either one of two common lines, thereby allowing the current flowing through the common line for supplying voltage to the counter electrodes to be divided into two subcurrents. Such an arrangement affords advantages in that voltage distortion in the common line can be minimized, and since the liquid crystal capacitance and the storage capacitance are connected in parallel, cross talk and horizontal brightness variation can be minimized, thereby improving the quality of the display substantially. Further, through provision of the common lines using high electrical resistance and thinner wiring, the aperture ratio can be improved substantially.

SECOND EMBODIMENT:

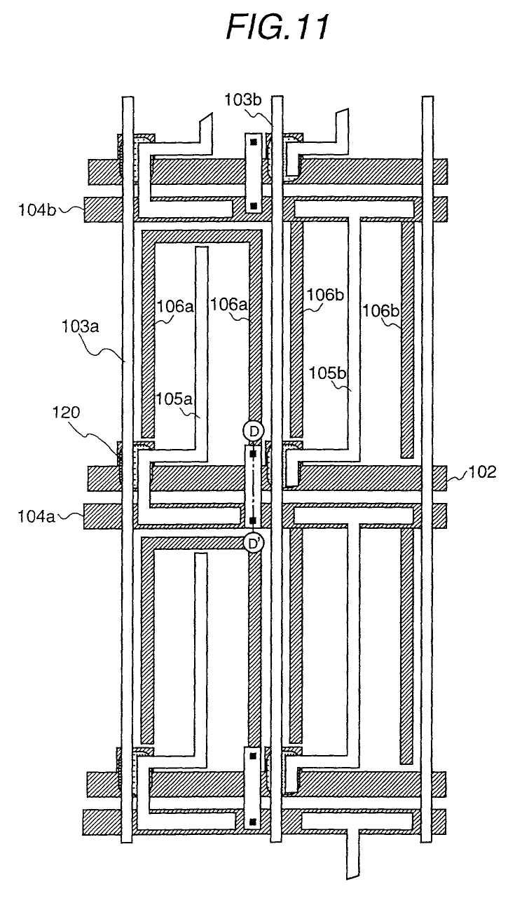

With reference to FIGS. 11 and 12, a second embodiment of the invention will be described. The features of this second embodiment other than the following are the same as those of the first embodiment.

FIG. 11 shows the construction of the bottom substrate 100 of this embodiment. This second embodiment is the same as the first embodiment, in that scanning lines 102 and signal lines 103 are disposed in a matrix array, and thin film transistors 120 are formed at respective intersections therebetween. However, this embodiment is different from the first embodiment in that pixel electrodes 105a and 105b, which are connected to the same scanning line 102 via respective thin film transistors 120, are disposed on the same side of the same scanning line 102. However, counter electrodes 106a and 106b, corresponding to these pixel electrodes 105a and 105b, are connected to two different common lines 104a and 104b, respectively. Thereby, a current flowing through a common line for supplying a voltage to the counter electrodes can be divided into two parts similar to the first embodiment, thereby reducing the load imposed on the common line, so as to minimize cross talk and horizontal brightness variation. Further, the aperture ratio can be improved also through provision of a common line which is thinner.

FIG. 12 shows a cross section in part of the bottom substrate 100 taken along line D-D′ in FIG. 11. Since it is necessary to connect a counter electrode 106 with a common line 104 by passing over scanning line 102, a metal layer 113, which is the same layer as the signal line, is used for this connection. Through-holes are bored in the SiN layer 109 interposed therebetween, and connections of the metal layer 113 with common line 104 and counter electrode 106 are provided. Here, bottom substrate 100 is defined to include also passivation layer 112 formed on the metal layer 113, alignment film 150 and polarizer 170 on the bottom of glass plate 101.

According to this embodiment of the invention, when one scanning line 102 is selected, and when display data are written in a group of pixels which are connected to this selected scanning line, the group of pixels in which display data is written are not disposed in a zigzag pattern as in the case of the first embodiment, but are aligned linearly. A description of the equivalent circuit and system configuration for this second embodiment are omitted since they are the same as for the first embodiment. Controller 401 of the second embodiment, however, does not have a function to convert data arrays into a staggered pattern of data.

Further, according to this second embodiment, respective pixels juxtaposed vertically or horizontally are connected to a different common line from each other. Thereby, it becomes possible simultaneously to provide for supply of an ac common potential, and to apply a liquid crystal application voltage of reverse polarity to respective pixels juxtaposed to each other. Through application of liquid crystal voltages of reverse polarity to juxtaposed pixels, flicker in the display can be minimized, thereby improving the quality of the display. Thereby, according to this second embodiment of the invention, further improvement in the quality of display due to elimination of flicker can be attained in addition to the advantages of the first embodiment.

THIRD EMBODIMENT:

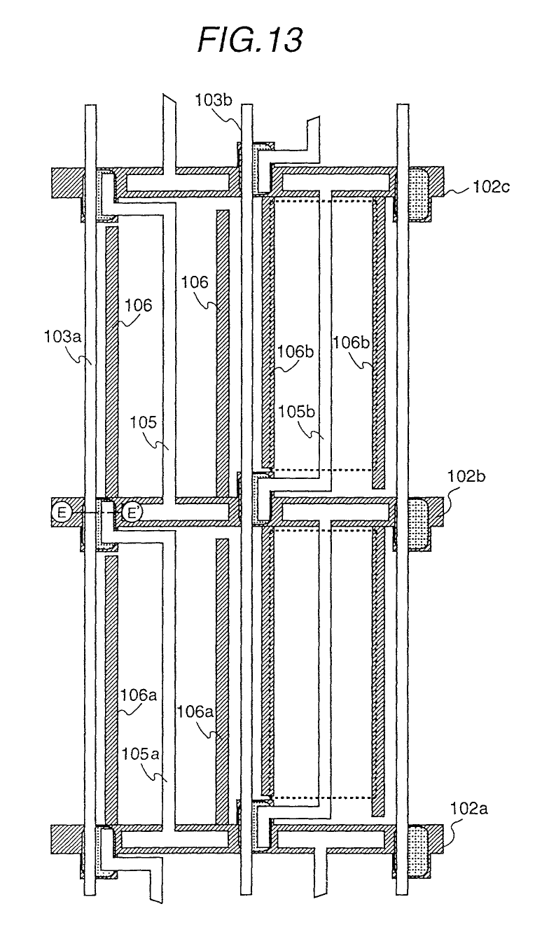

With reference to FIG. 13, the configuration of the bottom substrate 100 of an active matrix-addressed liquid crystal display device according to a third embodiment of the invention will be described. In this embodiment, it will be noted that the common lines have been eliminated.

Scanning lines 102 and signal lines 103 are disposed in a matrix array, and a thin film transistor 120 is formed at each intersections having these lines as two of its terminals. Another terminal of the TFT 120 is connected to a pixel electrode 105, which in conjunction with counter electrode 106 constitutes a switch to apply a voltage across the liquid crystal layer interposed between the counter electrode and the pixel electrode. Further, each counter electrode 106 is connected to a scanning line 102, which is different from the scanning line 102 to which a pixel electrode 105 corresponding thereto is connected.

Here, in this arrangement, respective pixel electrodes 105 which are connected to the same scanning line 102 via respective thin film transistors 120 are disposed in a zigzag (staggered) pattern along this same scanning line 102 alternately on the upper and the lower sides thereof for each pixel. For example, in FIG. 13, pixel electrode 105a is disposed toward the lower side of scanning line 102b, while the next pixel electrode 105b, which is connected to the same scanning line 102b is disposed toward the upper side of the scanning line 102b. In this instance, counter electrode 106a corresponding to pixel electrode 105a is connected to scanning line 102a of the next row, while counter electrode 106b corresponding to pixel electrode 105b is connected to scanning line 102c of the preceding row.

In such an arrangement, according to this embodiment of the invention, when a certain scanning line 102, more particularly line 102b, is selected, and display data is written into a group of pixels connected to this scanning line 102b, the group of pixels connected thereto and written in the display data are not aligned linearly, but are arranged in a staggered pattern across the selected scanning line 102b upward and downward for each pixel (such as 105a and 105b). Further, a current flowing through the scanning line for supplying a voltage to the counter electrodes of the selected group of pixels can be carried by the two scanning lines 102a and 102c, so that a load imposed on scanning line 102 can be reduced, and voltage distortion can be minimized. Therefore, horizontal cross modulation and horizontal brightness variation can be minimized as well. Still further, the fact that the load on the scanning line is reduced substantially means that a thinner scanning line having a higher electrical resistance can be used without deteriorating the display quality. Thereby, through provision of the thinner scanning line, the aperture ratio of the display can be improved substantially. Still further, since the area occupied by the common lines can be used also as a light transmittance region, a further improvement in the aperture ratio can be realized according to this embodiment of the invention.

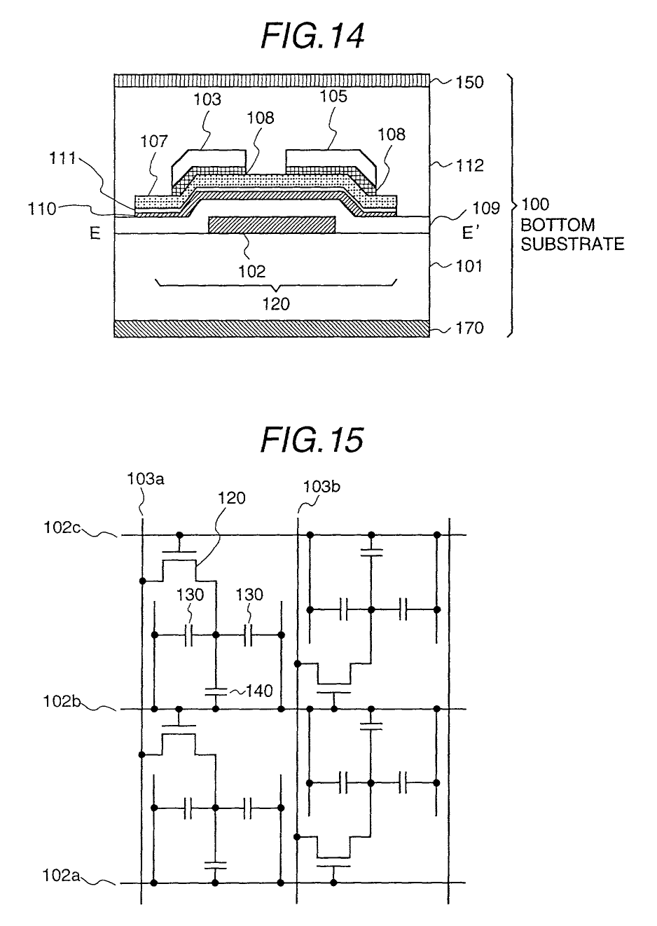

By way of example, in order to accomplish a structure in which the common line is eliminated, and in which the counter electrode 106 is connected directly to a scanning line 102 without interposing a TFT therebetween, it is necessary to provide for an active element which has an enhancement characteristic, for example, that can shift the threshold of the thin film transistor. With reference to FIG. 14, a thin film transistor 120 according to the third embodiment of the invention is shown, which is a cross-sectional view in part of the bottom substrate 100 taken along line E-E′ of FIG. 13. This thin film transistor 120 is comprised of a pixel electrode (source electrode) 105, a signal line (drain electrode) 103, a scanning line (gate electrode) 102, a-Si layer 107, and a gate insulation layer including SiN layer 109, SiO₂ layer 110 and SiO₂ film 111 doped with N. Further, in order to provide for ohmic contacts between a-Si layer 107 and signal line 103 as well as pixel electrode 105, an ohmic contact layer 108 using n-type a-Si doped with phosphor is formed therebetween. A passivation layer 112 is formed on the surface of this thin film transistor 120, and alignment film 150 is also provided thereon. By providing these layers and the polarizer 170 provided under glass plate 101, bottom substrate 100 is defined. The thin film transistor 120 according to this embodiment of the invention can shift its threshold to a high voltage of 12V, for example, by applying a voltage of 100V for 2 seconds across scanning line (gate electrode) 102 and pixel electrode (source electrode) 105, and signal line (drain electrode) 103.

Now, a drive method for this embodiment of the invention will be described. FIG. 15 shows an equivalent circuit of the bottom substrate structure 100 of FIG. 13 of the liquid crystal display panel according to the third embodiment of invention. With respect to one scanning line 102b, the two scanning lines 102a and 102b function as corresponding common lines, and also there are provided two different signal lines 103a and 103b corresponding thereto. In each pixel area surrounded by these scanning lines and signal lines, there are provided a thin film transistor 120, a storage capacitance 130 and a liquid crystal capacitance 140, assuming the liquid crystal itself has a capacitance. Liquid crystal capacitance 140 and storage capacitance 130 constitute a parallel capacitance also in this embodiment. A description of the system configuration of this embodiment is omitted since it is the same as that of the first embodiment.

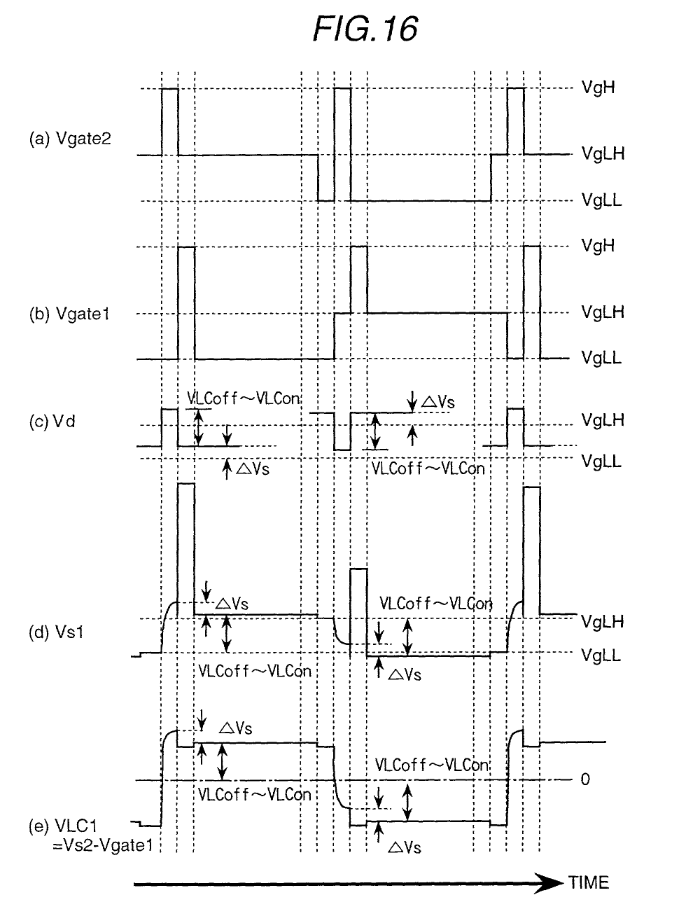

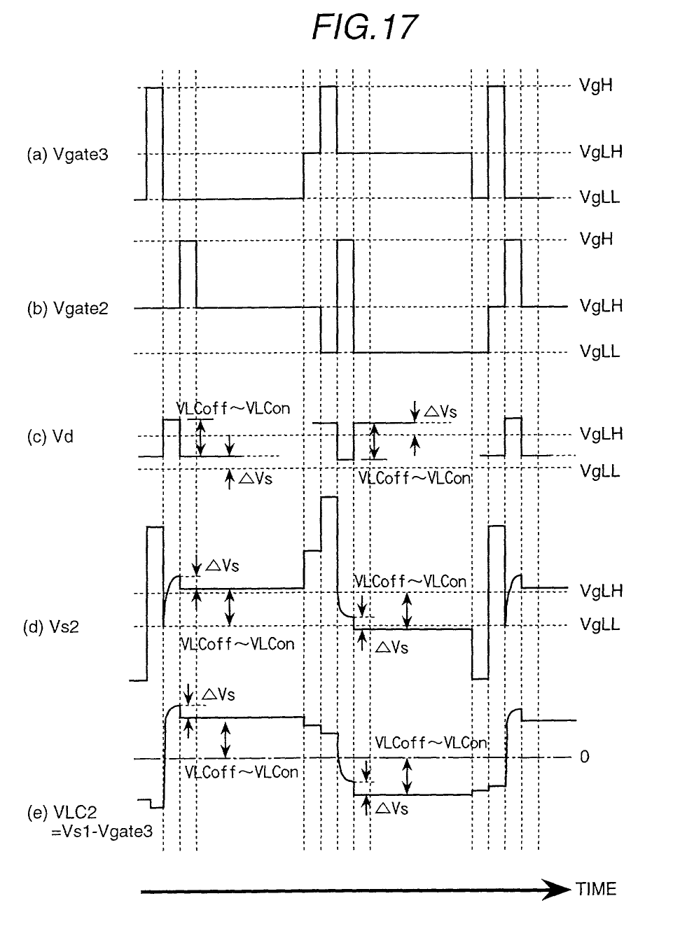

FIGS. 16 and 17 show waveforms of the drive voltages for this embodiment of the invention. In particular, FIG. 16 shows voltage waveforms for driving pixel electrode 105a, and FIG. 17 shows voltage waveforms for driving pixel electrode 105b. More particularly, line (b) FIG. 16 shows scanning voltage Vgate1 applied to scanning line 102a, while line (a) in FIG. 16 and line (b) in FIG. 17 show scanning voltage Vgate2 applied to scanning line 102b, and line (a) in FIG. 17 shows scanning voltage Vgate3 applied to scanning line 102c. Further, lines (c) in FIG. 16 and in FIG. 17 show signal voltage Vd applied to respective signal lines (for example, 103a and 103b in FIG. 15). Still further, lines (d) in FIG. 16 and in FIG. 17 show voltage Vs1 and Vs2 at pixel electrode 105a and 105b, respectively, and line (e) in FIG. 16 and in FIG. 17 show voltage V_{LC1} and V_{LC2} applied across respective liquid crystal layers in respective pixels (a voltage applied across both electrodes of liquid crystal capacitance 140).

Scanning voltages Vgate1, Vgate2 and Vgate3 include select voltage level VgH, non-select high voltage level VgLH and non-select low voltage level VgLL, respectively. The period of time for applying the select-voltage and the cycle of its application are, for example, 25 μs and 16.6 ms, respectively. Selection of respective scanning lines is done one at a time, and in the order of Vgate3, Vgate2 and Vgate1, for example, as seen in FIGS. 16 and 17. Two levels of non-select voltage are applied by switching-over between non-select high voltage level VgLH and non-select low voltage level VgLL sequentially. Timing of this switching-over is set at 25 μs prior to application of select-voltage level VgH. Further, since non-select high voltage level VgLH and non-select low voltage level VgLL are changed over for every scanning line, when one scanning line is selected (for example, 102b with Vgate2=VgH), the other two scanning lines (for example, 102a with Vgate1, and 102c with Vgate3) interposing 102b therebetween have the same potential (for example, Vgate1=Vgate3=VgLH or VgLL).

At this time, signal line voltage Vd is set at a value of VgLH±V_{LC} or VgLL±V_{LC} in order to apply a liquid crystal application voltage V_{LC} across the liquid crystal layer, which application voltage is set on the basis of reference voltages which are scanning line voltages Vgate1 and Vgate3 of the other two scanning lines (preceding scanning line and the following scanning line). Other parameters for setting this signal line voltage Vd are the same as in the first embodiment of the invention. However, in this embodiment of the invention, since its reference voltages Vgate1 and Vgate3 are the same, every signal line is set at values of the liquid crystal application voltage of the same polarity. However, since Vgate1 and Vgate2 are not the same, its polarity must be reversed with time.

Upon application of these signal voltages, potentials Vs1 or Vs2 at respective pixel electrodes in respective pixels maintain values of VgHL(or VgLL)±V_{LC} in most of its retention period relative to reference voltages VgLH or VgLL. Further, actual voltages V_{LC1} or V_{LC2} across its liquid crystal layer become equal to the difference between the voltages of respective pixel electrode potentials (Vs1 or Vs2) and respective counter electrode potentials corresponding thereto, which are equal to respective scanning lines thereof (Vgate1 or Vgate3). In this embodiment of the invention, in a period of 50 μs, including both periods prior to writing and post writing, liquid crystal application voltage V_{LC} becomes different from its set value; however, this period of time is negligible in comparison with an overall retention period of 16.6 ms, thereby causing no problem that could possibly affect display characteristics.

According to this embodiment of the invention, since respective counter electrodes of respective pixels in a group selected by one scanning line are connected to two different scanning lines, disposed on opposite sides of the selected scanning line, a current to respective counter electrodes in the selected group is supplied using the two different scanning lines during a non-select period thereof, thereby minimizing distortion of the scanning voltage during the non-select period, and since the liquid crystal capacitance and the storage capacitance form a parallel capacitance, horizontal cross modulation and horizontal brightness variation are minimized. Still further, since respective pixels juxtaposed to each other in vertical or horizontal directions are charged with liquid crystal application voltages having a reverse polarity from each other, the occurrence of flicker is suppressed, thereby substantially improving the display quality. Still more, a reduction of the load on the scanning line means that the diameter of the scanning line can be reduced so as to have a higher electrical resistance without deteriorating the display quality. Thereby, through provision of a thinner scanning line, the aperture ratio of the display panel can be improved. Still further improvement in the aperture ratio can be achieved since the areas used by the common lines can be utilized as a light transmittance area.

FOURTH EMBODIMENT:

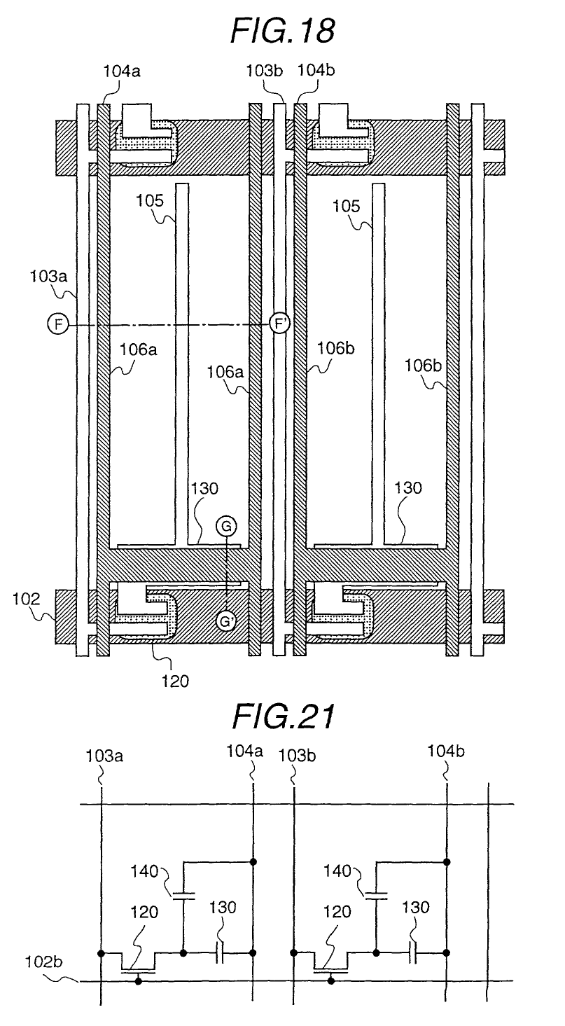

With reference to FIG. 18, there is shown a bottom substrate 100 of an active matrix-addressed liquid crystal display according to a fourth embodiment of the invention.

Scanning lines 102 and signal lines 103 are disposed in a matrix array, and, at each intersection thereof, a thin film transistor 120 is formed having these two lines as its terminals. Another terminal of the thin film transistor 120 is connected to pixel electrode 105, which functions as a switch to apply a liquid crystal application voltage across its liquid crystal layer between the pixel electrode 105 and counter electrode 106. In this fourth embodiment, counter electrode 106 is disposed along signal line 103 in parallel therewith, which functions also as a common line.

In the arrangement described above, the number of common lines is the same as the number of signal lines (or it may be assumed in effect to be equal to twice the number of signal lines), so that a current for supplying a voltage to the counter electrode can be subdivided into a number of common lines equal to the number of signal lines (or twice the number of signal lines). Thus, the load carried by each common line is reduced, thereby minimizing voltage distortion therein. Also, the cross talk (or cross modulation) and horizontal brightness variation can be minimized. Further, since the counter electrode is adapted to function also as a common line, the area occupied by the common line can be reduced, thereby improving the aperture ratio.

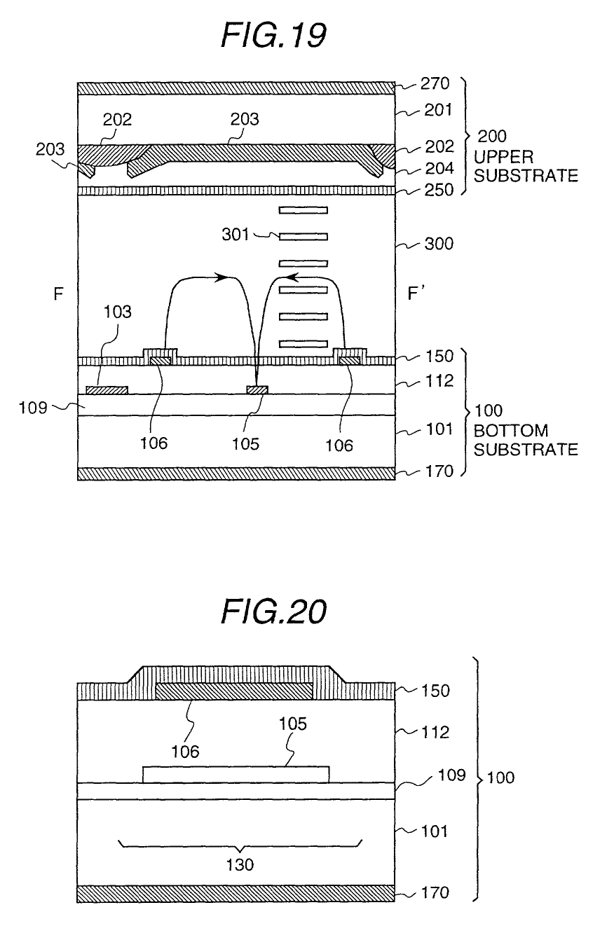

Now, with reference to FIG. 19, a cross-section in part of a liquid crystal panel taken along line F-F′ of FIG. 18 will be described. Bottom substrate 100 and upper substrate 200 have transparent glass plates 101 and 201, respectively, which are 0.7 mm thick and have a polished surface. On the bottom substrate 100, there are formed signal a line 103, a pixel electrode 105 and counter electrodes 106, as illustrated in FIG. 18, and also a SiN layer 109 is provided for isolating these electrodes from each other and a passivation layer 112 is provided for protection of wiring. On the other glass substrate 201, a black matrix 202 made of a low electric conductivity material is formed in order to improve the contrast of the display by preventing light from leaking through a gap around the area between pixel electrode 105 and counter electrode 106. Three primary color filters 203 of red (R), green (G) and blue (B) stripes are formed thereon. Further, a transparent planarization polymer layer 204 for surface planarization is laminated on the surface of the color filter 203, thereby completing fabrication of the upper substrate 200.

Alignment films 150 and 250 are formed on respective surfaces of the inner most parts of these two substrates, which are subjected to a rubbing process, and then a liquid crystal composition 300 is filled in a space between these two substrates. Finally, the outermost surfaces of these two substrates are sandwiched by two polarizers 170 and 270 to complete fabrication of the liquid crystal display panel.

FIG. 20 shows a cross-section in part of the bottom substrate 100 taken along line G-G′ in FIG. 18. This represents a cross-section of the storage capacitance 130. This storage capacitance 130 is provided in the bottom substrate 100 and on SiN layer 109 over glass plate 101, and is formed by common line 106 (104) and pixel electrode 105 isolated by passivation layer 112 interposed therebetween. Since this storage capacitance 130 is arranged to form a parallel capacitance with the liquid crystal capacitance, even if the potential of the common line 104 (106) changes due to capacitance coupling with signal line 103, its liquid crystal application voltage does not change substantially, thereby suppressing the occurrence of cross modulation or cross talk in vertical directions.

A drive method for driving the active matrix addressed liquid crystal display according to this embodiment of the invention will be described with reference to FIG. 21. FIG. 21 shows an equivalent circuit of FIG. 18, in particular, of its bottom substrate 100. For selected one scanning line 102, there are provided the same number (or two-fold) of common lines (counter electrodes) as the number of signal lines. In each one of the pixels surrounded by scanning lines and signal lines, there are provided a thin film transistor 120, a storage capacitance 130 and a liquid crystal capacitance 140 formed by the liquid crystal layer itself. In FIG. 21, it is clearly shown that liquid crystal capacitance 140 and storage capacitance 130 are in a parallel capacitance connection. The description of the system configuration of this embodiment is omitted, since it is the same as in the first embodiment. It should be noted, however, that controller 401 in this embodiment does not have a function to convert its data array from a sequential display pattern to a staggered display pattern.

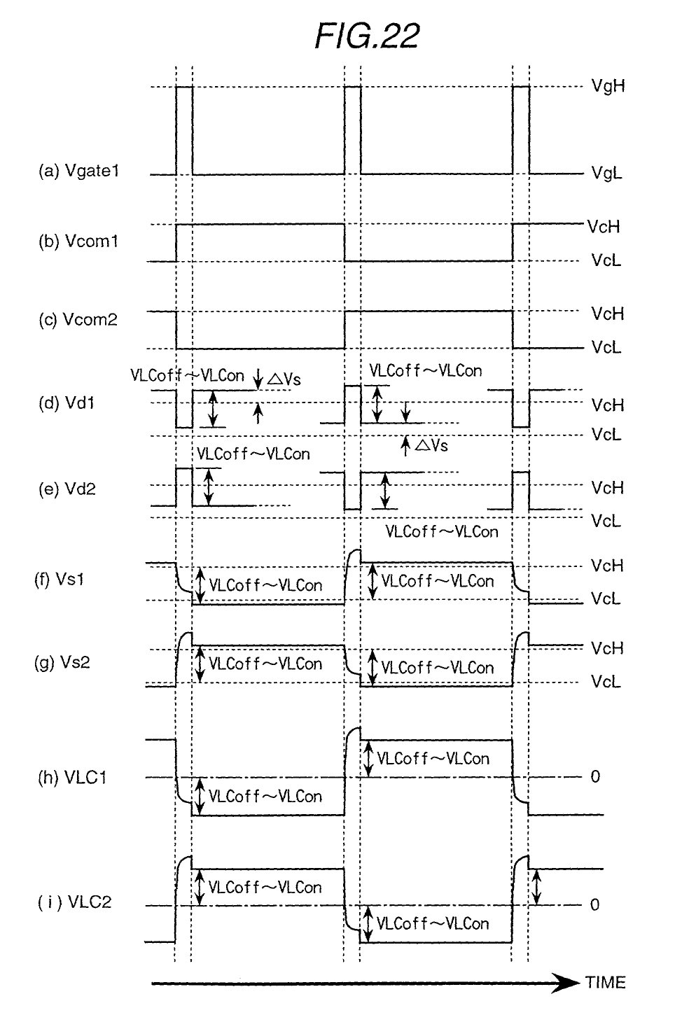

FIG. 22 depicts the waveforms of drive voltages for this embodiment. Line (a) depicts scanning voltage Vgate1, which is applied to one scanning line (for example, 102 in FIG. 21). Line (b) depicts common voltage Vcom1, which is applied to one common line (for example, 104a in FIG. 21), and line (c) depicts another common voltage Vcom2 which is applied to another common line (for example, 104b in FIG. 21) next to common line 104a. Further, line (d) depicts signal voltage Vd1, which is applied to a signal line (for example, 103a in FIG. 21) of the pixel to which the common line 104a receiving voltage Vcom1 is connected, and line (e) depicts signal voltage Vd2 which is applied to another signal line (for example, 103b in FIG. 21) disposed next to the signal line 103a. Lines (f) and (g) show pixel electrode voltages Vs1 and Vs2 of respective pixels, to which signal voltages Vd1 and Vd2 are applied, respectively. Then, lines (h) and (i) show liquid crystal application voltages V_{LC1} and V_{LC2}, which are applied across liquid crystal layers in respective pixels.

Setting the voltages for the scanning lines and common lines in this embodiment is achieved in the same way as in the first embodiment. Setting of the voltage for the signal line is also achieved in approximately the same way as in the first embodiment. Although Vd1 and Vd2 are set at values of the liquid crystal application voltages having a reverse polarity from each other, since the reference voltage Vcom does not change when the next scanning line is selected, the polarity of these signal voltages are not altered during a period of time required for writing one frame.

For all such differences as described above, pixel electrode voltage Vs1 or Vs2 and actual liquid crystal application voltage V_{LC1} or V_{LC2} are the same as in the first embodiment.

In this fourth embodiment of the invention, since a capacitance coupling per unit of line of the signal line 103 with common line 104 or counter electrode 106 is large, depending on the magnitude of the signal voltage, a counter electrode potential, which is equal to a common line potential, changes during the retention period of the liquid crystal application voltage. However, since both the liquid crystal capacitance 140 and the storage capacitance 130 are connected to the common line, even if a redistribution of charges retained by the pixel electrode occurs, the liquid crystal voltage V_{LC1} or V_{LC2} does not change substantially, thereby preventing the occurrence of a display deficiency, such as cross talk in vertical directions.

According to this fourth embodiment of the invention, the following advantages have been achieved. Since the counter electrodes of the pixels in a group selected by one scanning line are connected to the same number of common lines (or twofold thereof) as that of the signal lines, each current flowing through a common line for supplying a voltage to the counter electrode is reduced substantially, thereby minimizing distortion in the common voltage. Still further, since the liquid crystal capacitance and the storage capacitance are connected in parallel, the horizontal cross talk and brightness variation are substantially reduced, and vertical cross talk is also eliminated, thereby improving the display quality. Still further, since an area previously required for the common lines can be reduced, provision of a higher aperture ratio and a higher brightness of display becomes possible.

FIFTH EMBODIMENT:

A fifth embodiment of the invention will be described in the following. The other features and arrangements of the fifth embodiment of the invention except for the following are the same as in the fourth embodiment of the invention.

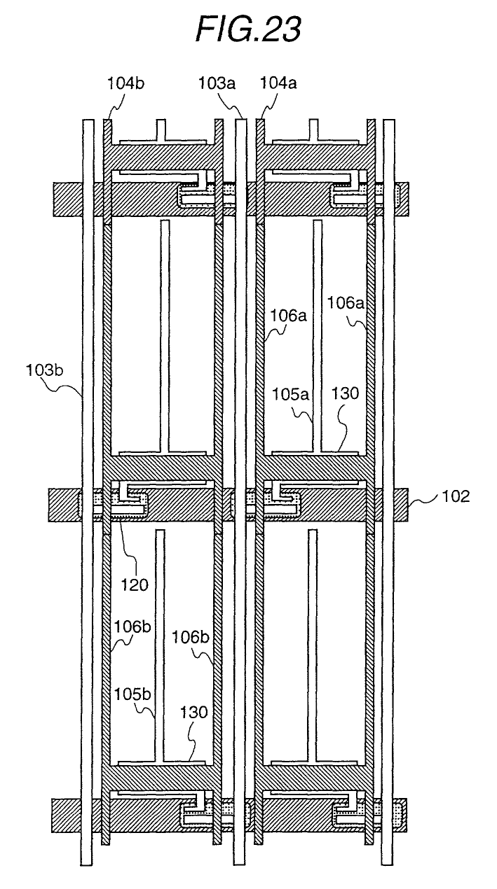

The structure of the bottom substrate 100 of this embodiment is shown in FIG. 23. The configuration of the fifth embodiment of the invention is such that scanning lines 102 and signal lines 103 are disposed in a matrix array, and at each intersection thereof a thin film transistor 120 is formed similar to that of the fourth embodiment. However, the fifth embodiment differs from the fourth embodiment in that respective pixel electrodes 105 in respective pixels which are connected to one signal line 103 via each thin film transistor 120 are disposed in a staggered pattern along the one scanning line 103 on both sides thereof, i.e. to the righthand side and to the lefthand side thereof, alternately for every pixel. For example, pixel electrode 105a is disposed to the righthand side of the signal line 103a, while the next pixel electrode 105b is disposed to the lefthand side thereof. In this arrangement, counter electrode 106a corresponding to pixel electrode 105a, which also functions as common line 104a, is disposed to the righthand side of signal line 103a, while counter electrode 106b corresponding to pixel electrode 105b, which also functions as common line 104b, is disposed to the lefthand side of signal line 103a.

In this arrangement also, the number of common lines equals the number of signal lines (or twofold thereof) as in the case of the fourth embodiment, so that the current which is to flow through a common line for supplying a voltage to its counter electrode can be supplied by two common lines, thereby reducing the unit load imposed on one common line, while minimizing horizontal cross talk and brightness variation. Further, since the counter electrode serves also as a common line, the area normally allocated to the common line can be eliminated to improve the aperture ratio of the display panel.

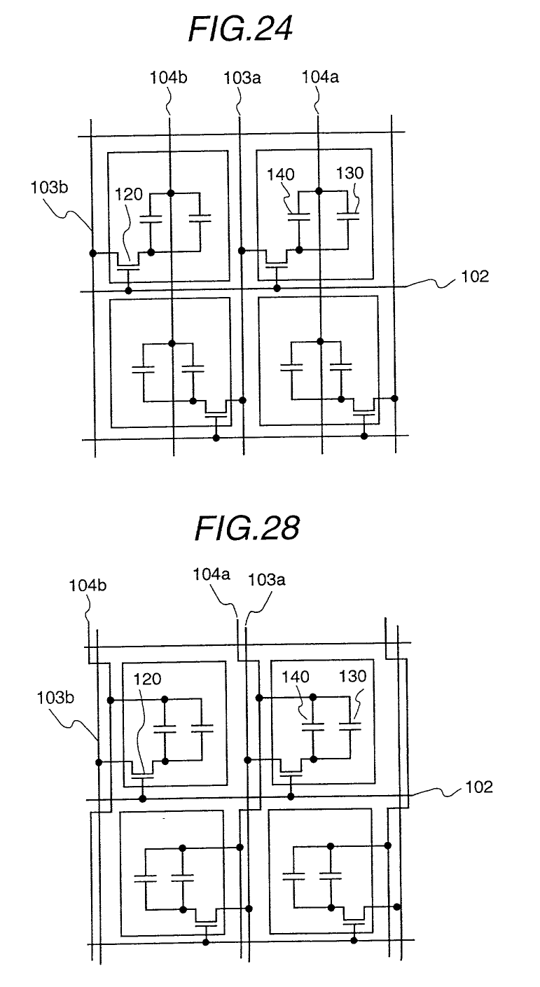

Now, a method of driving the display panel according to the fifth embodiment of the invention will be described in the following. FIG. 24 shows an equivalent circuit of the bottom substrate 100, as illustrated in FIG. 23, of an active matrix addressed liquid crystal display according to this embodiment of the invention. A main difference between the fifth embodiment and the fourth embodiment is that respective thin film transistors 120 connected to one signal line 103 are disposed in a staggered pattern alternately to the righthand side and to the lefthand side with respect to the signal line 103. In this configuration according to the fifth embodiment, since data transferred by one single signal line is distributed to pixels on both sides thereof, i.e., to the leftside and to the rightside thereof alternately for every column line, another method of data array conversion different from that of the first embodiment is required.

A description of the system configuration of the fifth embodiment of the invention is omitted since it is the same as that of the first embodiment. However, controller 401 of the fifth embodiment has another type of data array conversion function which is different from that of the first embodiment.

The data array conversion circuit used in this embodiment is the same as that shown in FIG. 8. Data array conversion controller 410 operates in response to control signals of one line data delimit signal 413 and data clock signal 414 in the same manner as in the first embodiment, and in response to every one line data delimit signal 413, a data array conversion mode and a non-data array conversion mode are switched over. In the non-data array conversion mode, the controller allows input data signal 412 to go through as output data 416 without subjecting it to data array conversion. In the data array conversion mode, controller 410 transfers a portion of data selected from the data signal 412 to data memory 411 to be stored therein and to be output in response to the next clock signal. Simultaneously, the controller reads out a portion of data, which was stored in response to the preceding clock signal, from data memory 411, and produces the output data signal 416 by combining the portion of data read out with a remaining portion of the input data 412.

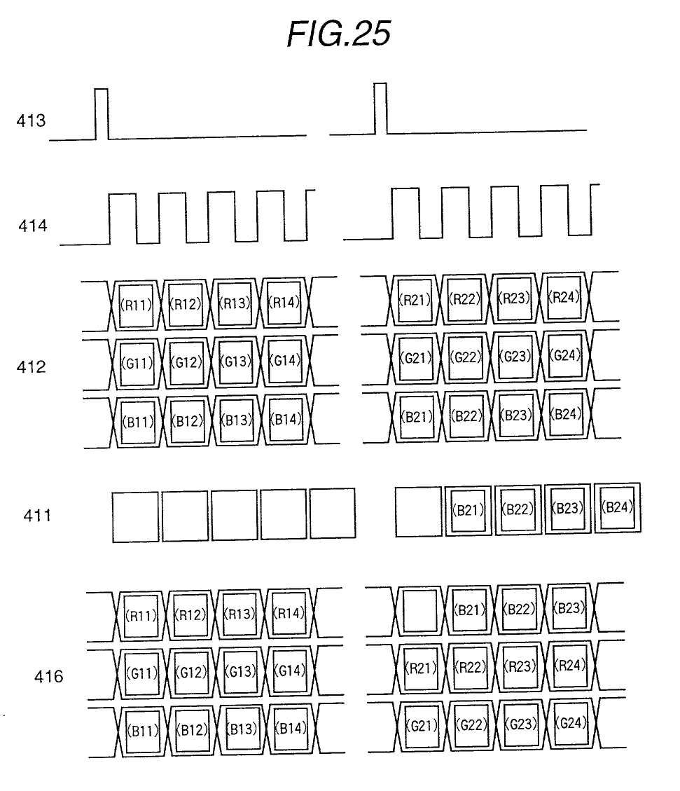

FIG. 25 shows timing charts of these operation. Actually, input data signal 412 includes three parallel inputs corresponding to the RGB colors, hence, arrays of pixels for the RGB colors are aligned laterally, so that data array conversion is executed for respective RGB data. Switching over between the data array conversion and the non-data array conversion modes is done in response to every one line data delimit signal 413. In the non-data array conversion mode, input data signal 412 and output data signal 416 are the same. However, in the data array conversion mode, in response to every clock signal 414, a B signal (for example, B22) in the input signal 412 is taken and transferred to data memory 411 via memory access line 415. Simultaneously, another B signal (for example, B21) previously stored in data memory 411 at the time of the preceding clock signal is read out and combined with the remaining portion of the input data signal, so as to be output as output data 416.

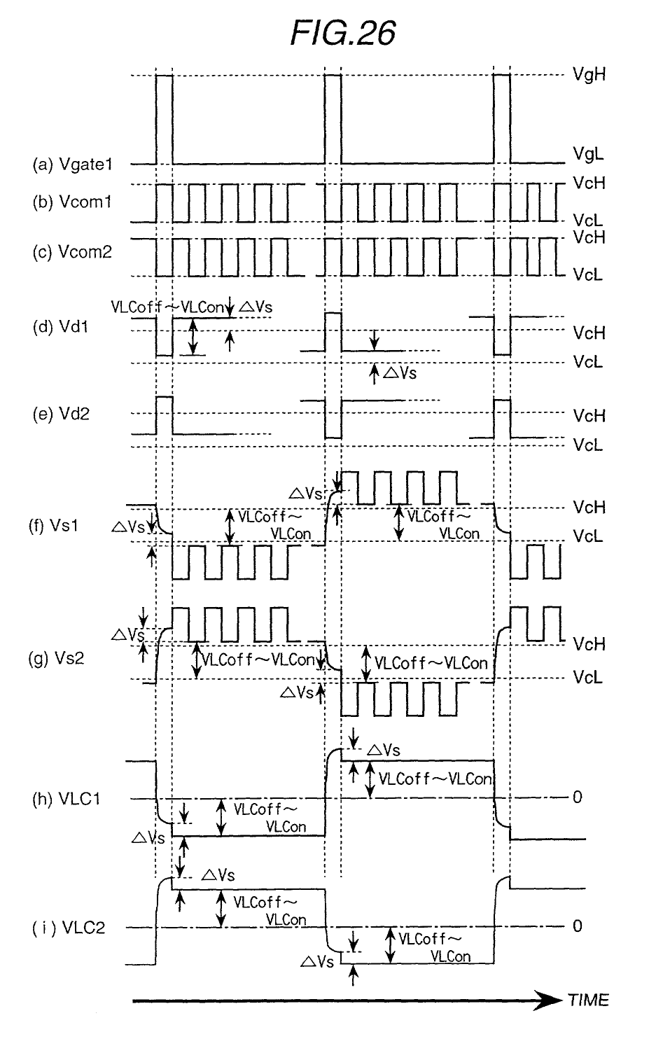

FIG. 26 shows the waveforms of the drive voltages for driving the display panel according to this embodiment of the invention. Line (a) depicts scanning voltage Vgate1, which is applied to one scanning line (for example, 102 in FIG. 24). Line (b) depicts common voltage Vcom1, which is applied to one common line (for example 104a in FIG. 24), and line (c) depicts common voltage Vcom2, which is applied to another common line (for example, 104b in FIG. 24) disposed next to the above-mentioned one common line 104a. Line (d) depicts signal voltage Vd1, which is applied to a signal line (for example, 103a in FIG. 24) connected to the pixel which is connected to the common line 104a and to which common voltage Vcom1 is applied, and line (e) depicts signal voltage vd2, which is applied to another signal line (for example, 103b in FIG. 24) disposed next to the above-mentioned signal line (103a). Lines (f) and 26(g) depict pixel electrode voltages Vs1 and Vs2 at respective pixel electrodes of respective pixels to which signal voltages Vd1 and Vd2 are applied, respectively. Lines (h) and (i) depict liquid crystal application voltages V_{LC1} and V_{LC2} applied across respective liquid crystal layers in respective pixels.

As for the voltage setting of the scanning line, it is the same as in the fourth embodiment of the invention. Further, as for voltage settings of the signal line, they are also the same as in the fourth embodiment, and therefore, Vd1 and Vd2 are set at the values of liquid crystal application voltages while having a reverse polarity with respect to each other. However, a cycle of switching over of the voltage polarity for the common line is not set at the one-frame cycle, but is set at every one line write cycle in this fifth embodiment of the invention. Also, in this arrangement, since a value of Vcom which becomes a reference when the next scanning line is selected does not change, the polarity of the signal voltage is not changed within a period of time required for writing one frame.

According to this fifth embodiment of the invention, since respective thin film transistors 120 connected to one signal line 103 are disposed in a staggered pattern on the lefthand side then on the righthand side alternately along the signal line, and since this staggered pattern is repeated for every signal line, it becomes possible to apply a liquid crystal application voltage of reverse polarity to each one of the pixels juxtaposed vertically and horizontally when the polarity of the potential of the signal voltage is reversed for writing another frame. The ability to apply an opposite polarity liquid crystal application voltage to each one of the pixels juxtaposed vertically and horizontally makes it possible to minimize display flickers, thereby improving the display quality substantially. Therefore, according to this fifth embodiment of the invention, even further improvement in the display quality as compared to the fourth embodiment can be achieved through elimination of display flickers.

SIXTH EMBODIMENT:

A sixth embodiment of the invention will be described in the following. The configuration of the sixth embodiment of the invention is the same as that of the fifth embodiment, except for the following factors.

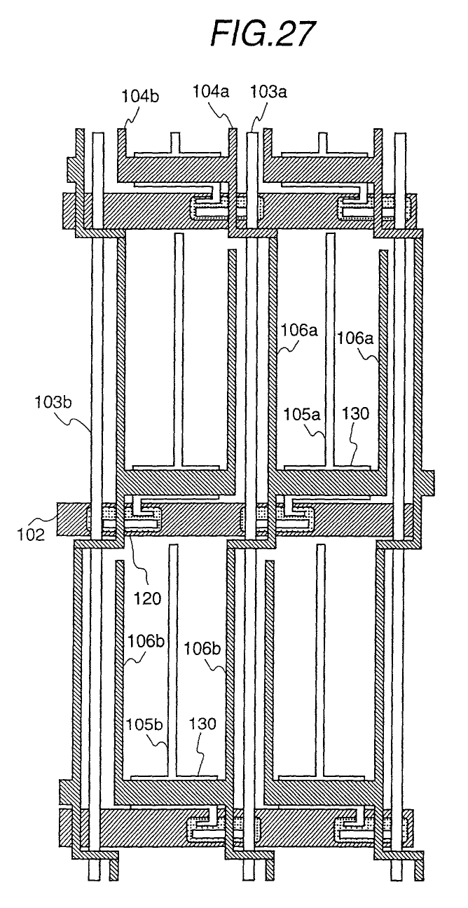

FIG. 27 shows the structure of the bottom substrate 100 of this embodiment. The sixth embodiment of the invention has the same construction as the fifth embodiment in that its scanning lines 102 and signal lines 103 are disposed in a matrix array, and respective thin film transistors provided at each intersection of the matrix are disposed in a staggered pattern along the signal lines 103. However, the sixth embodiment of the invention differs from the fifth embodiment in that its common line is disposed in contact with respective pixels disposed alternately in a staggered pattern with respect to the signal line for every column line thereof. For example, counter electrode 106a, which is disposed to the righthand side of signal line 103a, and the next counter electrode 106b, which is connected to counter electrode 106a, is disposed to the lefthand side of the signal line 103a.

In this case, the number of common lines equals the number of signal lines plus 1 (or is equal to twofold of the signal lines plus 2). Thereby, a current flowing through the common line for supplying a voltage to the counter electrode can be supplied by a plural number of common lines equal to the number of signal lines plus 1 (or twofold of the signal lines plus 2), thereby minimizing the load on the common line, and substantially reducing the horizontal cross talk and brightness variation. Further, since the counter electrode also functions as a common line, the area of the common line can be reduced in order to improve the aperture ratio of the display panel.

Now, a method for driving the display panel according to the sixth embodiment of the invention will be described. FIG. 28 shows an equivalent circuit of the bottom substrate 100 of FIG. 27 in an active matrix addressed liquid crystal display according to the sixth embodiment of the invention. The main difference between this structure and that of the fifth embodiment of the invention resides in that one common line 104 is folded in a zigzag pattern with respect to one signal line 103 so as to be connected alternately to respective pixels which are also disposed in a staggered pattern, to the lefthand side and to the righthand side with respect to the signal line 103. In this structure of the sixth embodiment of the invention, since signal data transmitted by one signal line is distributed alternately to respective pixels on the lefthand side and on the righthand side thereof, and for every column line thereof, the same data array conversion process as in the fifth embodiment is required.

A description of the system configuration of the sixth embodiment of the invention is omitted since it is the same as in the fifth embodiment. Also, a description of the data array conversion function is omitted, since it is the same as in the fifth embodiment.

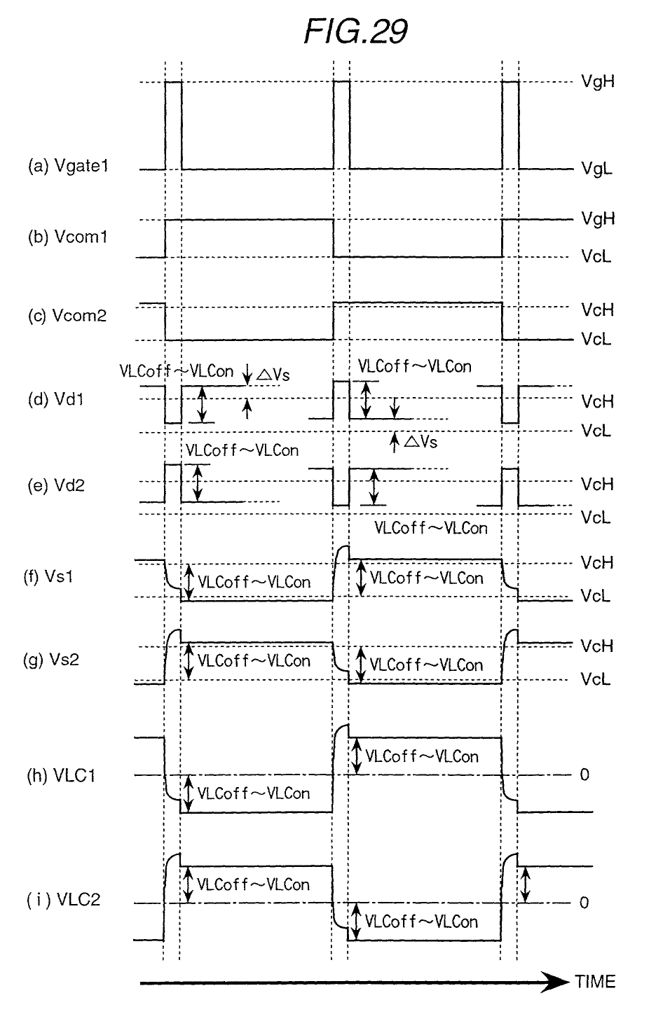

FIG. 29 shows the waveforms of the drive voltages in the sixth embodiment of the invention. Line (a) depicts the scanning voltage Vgate1, which is applied to a scanning line (for example, 102 in FIG. 28). Line (b) depicts common line voltage Vcom1, which is applied to one common line (for example, 104a in FIG. 28), and line (c) depicts another common line voltage Vcom2, which is applied to another common line (for example, 104b in FIG. 28) disposed next to the preceding common line (104a). Line (d) depicts signal voltage Vd1 which is applied to a signal line (for example 103a in FIG. 28) of the pixel which is connected to the common line to which common line voltage Vcom1 is applied, and line (e) depicts another signal voltage Vd2, which is applied to another signal line (for example, 103b in FIG. 28) disposed next to the preceding signal line (103a). Further, lines (f) and (g) show pixel electrode voltages Vs1 and Vs2 at respective pixel electrodes in respective pixels, to which signal voltages Vd1 and Vd2 are applied, respectively. Lines (h) and (i) show liquid crystal application voltages V_{LC1} and V_{LC2} which are applied across respective liquid crystal layers in respective pixels.

The voltage setting of the scanning line is the same as in the fifth embodiment of the invention. Also, the voltage setting of the signal line is the same as in the fifth embodiment, and thereby, Vd1 and Vd2 are set at values of the liquid crystal application voltages having a reverse polarity with respect to each other. However, a cycle of switching of the voltage polarity for the common line is performed not at one line write cycle, but at one frame cycle. Also, in this voltage setting condition, since the value of Vcom, which becomes a reference voltage when the next scanning line is selected, does not change, the signal voltage does not need to be changed in polarity within a period of time for writing one frame.

In this embodiment of the invention, the switching cycle for switching over the polarity of the common line is not one line write cycle, as in the fifth embodiment, but is one frame write cycle. Thereby, the voltage line delay due to the switching of the polarity of the common line is minimized, thereby suppressing the occurrence of display defects, such as vertical cross modulation and the like. Still further, since the switching frequency for switching over the polarity of the common line decreases, the power consumption in the common line becomes small. As a result, according to this embodiment of the invention, further improvements in the display quality and power consumption beyond those in the fifth embodiment can be achieved.

As stated above, according to the invention, a high-performance active matrix addressed liquid crystal display is provided, which features a high quality display without horizontal cross talk and brightness variation, as well as elimination of display flickers in a modified version of the invention. Further, since the voltage distortion can be minimized according to the invention, common lines and scanning lines of thinner gauge can be used, thereby substantially improving the aperture ratio of the active matrix addressed liquid crystal display. Still further, since the potential of the counter electrode of the pixels can be charged in the ac mode in one frame cycle, a low signal voltage in a longer cycle ac mode can be used, thereby substantially improving the power consumption in the active matrix addressed liquid crystal display.

What is claimed is:

1. A liquid crystal display device having a pair of opposed substrates, at least one of which is transparent, a liquid crystal layer interposed between said pair of substrates, and an electrode structure formed on one of said pair of substrates, which electrode structure produces an electric field which is disposed predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements in a respective pixel;
a plurality of common lines, each formed between said ones of plurality of scanning lines; and
at least one counter electrode formed in each one of said plurality of pixels, said at least one counter electrode being connected to one of said plurality of common lines; wherein
at least one of pixel electrodes in respective pixels which are juxtaposed in the direction of a scanning line is arranged to form a storage capacitance with at least one of said plurality of common lines which is associated thereto alternately different from pixel to pixel.

2. A liquid crystal display device according to claim 1, further comprising a drive unit for applying a voltage to said claim plurality of signal lines, said plurality of scanning lines and said plurality of common lines, respectively, wherein said drive unit:
applies two different voltages to said plurality of common lines alternately for every line, said two different voltages being interchanged for every one frame write cycle, and supplies a liquid crystal application voltage to said plurality of signal lines by reversing the polarity of the voltage for every line and every one frame write cycle, said liquid crystal application voltage including a voltage applied to said plurality of common lines as a reference voltage.

3. A liquid crystal display device having a pair of opposed substrates, at least one of which is transparent, a liquid crystal layer interposed between said pair of substrates, an electrode structure formed on one of said pair of substrates, which electrode structure produces an electric field which is predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements in a respective pixel; and
at least one counter electrode formed in each one of said plurality of pixels, said at least one counter electrode being connected to one of said plurality of common lines; wherein
at least one of pixel electrodes in respective pixels which are juxtaposed in the direction of a scanning line is arranged to form a storage capacitance with at least one of said plurality of common lines which is associated thereto alternately different from pixel to pixel.

4. A liquid crystal display device according to claim 3, further comprising a drive unit for applying a voltage to said plurality of signal lines and said plurality of scanning lines, respectively, wherein said drive unit:
interchanges a portion of voltage data in time sequence to be applied to said plurality of signal lines; and
exchanges a portion of voltage data to be applied to said plurality of scanning lines with a portion of voltage data to be applied to another one of said plurality of scanning lines.

5. A liquid crystal display device according to claim 3, wherein said drive unit:
supplies a liquid crystal application voltage to said plurality of signal lines by reversing the polarity of the voltage thereof for every line and every one frame writing period of time, said liquid crystal application voltage including a non-selected voltage of said plurality of scanning lines in a non-selected period of time as a reference voltage thereof.

6. A liquid crystal display device having a pair of opposed substrates, at least one of which is transparent, a liquid crystal layer interposed between said pair of substrates, and an electrode structure formed on one of said pair of substrates, which electrode structure produces an electric field which is predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements; and
at least one counter electrode formed in each one of said plurality of pixels, said at least one counter electrode thereof being connected to one of said plurality of scanning lines; wherein
the counter electrodes of respective pixels juxtaposed in the direction of said plurality of scanning lines are connected to different scanning lines.

7. A liquid crystal display device according to claim 6, further comprising a drive unit for applying a voltage to said plurality of signal lines and said plurality of scanning lines, respectively, wherein said drive unit:
interchanges a portion of voltage data in time sequence to be applied to each one of said plurality of signal lines; and
exchanges a portion of voltage data to be applied to said plurality of scanning lines with a portion of voltage data to be applied to another one of said plurality of scanning lines.

8. A liquid crystal display device according to claim 6, further comprising a drive unit for applying a voltage to said plurality of signal lines and said plurality of scanning lines, respectively, wherein said drive unit:
supplies a liquid crystal application voltage to said plurality of signal lines by reversing the polarity of the voltage thereof for every line and every one frame writing period of time, said liquid crystal application voltage including a non-selected voltage of said plurality of scanning lines in a non-selected period of time as a reference voltage thereof.

9. A liquid crystal display device according to claim 6, wherein each pixel electrode of each one of said plurality of pixels juxtaposed in the direction of said plurality of scanning lines is connected to a different scanning line, and wherein a storage capacitance is formed between said each pixel electrode and the scanning line to which it is connected.

10. A liquid crystal display device having a pair of opposed substrates, at least one of which is transparent, a liquid crystal layer interposed between said pair of substrates, and an electrode structure formed on one of said pair of substrates, which electrode structure produces an electric field which is predominantly in parallel with said pair of substrates, wherein said electrode structure comprises:
a plurality of scanning lines;
a plurality of signal lines in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements;
a plurality of common lines formed between said plurality of scanning lines, respectively; and
at least one counter electrode formed in each one of said plurality of pixels, said at least one counter electrode being connected to one of said plurality of common lines; wherein
the counter electrodes of pixels juxtaposed in the direction of said scanning lines are connected to different common lines.

11. A liquid crystal display device according to claim 10, further comprising a drive unit for applying a voltage to said plurality of signal lines, said plurality of scanning lines and said plurality of common lines, wherein said drive unit comprises:
applies two different voltages to said plurality of common lines alternately for every line, said two different voltages being interchanged for every one frame writing cycle; and
supplies a liquid crystal application voltage to said plurality of signal lines by reversing the polarity of the voltage thereof for every column line and every one frame writing period of time, said liquid crystal application voltage including a voltage applied to said plurality of common lines as a reference voltage.

12. A liquid crystal display device according to claim 11, wherein at least one of pixel electrodes in respective pixels which are juxtaposed in the direction of a scanning line is arranged to form a storage capacitance with at least one of said plurality of common lines which is associated thereto alternately different from pixel to pixel.

13. A liquid crystal display device having a pair of opposed substrates, at least one of which is transparent, a liquid crystal layer interposed between said pair of substrates, and an electrode structure formed on one of said pair of substrates, which electrode structure produces an electric field which is predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements; and
at least one counter electrode formed in each one of said plurality of pixels, said at least one counter electrode being connected to one of said plurality of scanning lines; wherein
each of the active elements of pixels juxtaposed in the direction of said scanning lines is connected to a different one of said plurality of scanning lines.

14. A liquid crystal display device according to claim 13, further comprising a drive unit for applying a voltage to said plurality of signal lines and said plurality of scanning lines, wherein said drive unit:
interchanges at least a part of voltage data in time sequence to be applied to said plurality of signal lines; and
interchanges at least a part of voltage data to be applied to one of said plurality of scanning lines with a part of voltage data to be applied to another one of said plurality of scanning lines.

15. A liquid crystal display device according to claim 14, wherein said drive unit:
supplies a voltage to said plurality of common lines by reversing the polarity of the voltage thereof for every line and every one frame writing charging period of time, said voltage including a non-selected voltage of said plurality of scanning lines in a non-selected period of time as a reference voltage.

16. A liquid crystal display device according to claim 14, wherein the pixel electrodes of pixels juxtaposed in the direction of said plurality of scanning lines form storage capacitances with different ones of said plurality of scanning lines.

17. A liquid crystal display device having a pair of opposed substrates, at least one of which is transparent, a liquid crystal layer interposed between said pair of substrates, and an electrode structure formed on one of said pair of substrates, which electrode structure produces an electric field which is disposed predominantly in parallel with said pair of substrates, wherein said electrode structure comprises:
a plurality of scanning lines;
a plurality of signal lines in a matrix pattern with said plurality of scanning lines so that a plurality of pixels are formed in areas surrounded by said plurality of signal lines and said plurality of scanning lines, respectively;
a plurality of active elements each formed in the vicinity of intersections of said matrix pattern;
a plurality of pixel electrodes each connected to a respective one of said plurality of active elements;
a plurality of common lines each formed between an adjacent two of said plurality of scanning lines; and
a plurality of counter electrodes each formed opposing to each corresponding pixel electrode in each one of said plurality of pixels; wherein
each one of said plurality of active elements of pixels juxtaposed in the direction of said scanning lines is connected to a different one of said plurality of scanning lines; and
each one of said plurality of counter electrodes of pixels juxtaposed in the direction of said scanning lines is connected to a same one of said plurality of common lines so that a current to be carried by a respective one of said plurality of common lines is reduced.

18. A liquid crystal display device according to claim 17, further comprising a drive unit for applying a voltage to said plurality of signal lines, said plurality of scanning lines and said plurality of common lines, wherein said drive unit applies two different kinds of voltages to said plurality of common lines alternately for every line, said two different kinds of common line voltages being interchanged for every one frame writing cycle; and
applies a liquid crystal application voltage to said plurality of signal lines by reversing the polarity of its voltage for every line and for every one frame writing cycle, said liquid crystal application voltage including a voltage applied to one of said plurality of common lines as a reference voltage.

19. A liquid crystal display device according to claim 17, wherein at least one of pixel electrodes in respective pixels which are juxtaposed in the direction of a scanning line is arranged to form a storage capacitance with at least one of said plurality of common lines which is associated thereto alternately different from pixel to pixel.

20. A liquid crystal display device having a pair of opposed substrates, at least one of which is transparent, a liquid crystal layer interposed between said pair of substrates, and an electrode structure formed on one of said pair of substrates, which electrode structure produces an electric field which is predominantly in parallel with said pair of substrates, wherein said electrode structure comprises:
a plurality of scanning lines;
a plurality of signal lines in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements in a respective pixel; and
at least one counter electrode formed in each one of said plurality of pixels, said at least one counter electrode being connected to one of said plurality of scanning lines; wherein
charged pixels of said plurality of pixels juxtaposed in the direction of said plurality of scanning lines, which have changed transmittance of light due to an application of voltages to signal lines and scanning lines corresponding thereto, are arranged in a staggered pattern on either side of the scanning lines corresponding thereto.

21. A liquid crystal display device according to claim 20, further comprising a drive unit for applying a voltage to said plurality of signal lines and said plurality of scanning lines, wherein said drive unit:
interchanges at least a part of voltage data to applied to each one of said plurality of signal lines in time sequence; and
exchanges at least a part of voltage data to be applied to one of said plurality of scanning lines with at least a part of voltage data to be applied to another one of said plurality of scanning lines.

22. A liquid crystal display device according to claim 20, further including a drive unit for applying a voltage to plurality of signal lines and said plurality of scanning lines, wherein said drive unit:
supplies a liquid crystal application voltage to said plurality of signal lines by reversing the polarity of the voltage thereof for every line and for every one frame writing period of time, said liquid crystal application voltage including a non-select voltage of said plurality of scanning lines in a non-select period of time as a reference voltage thereof.

23. A liquid crystal display device according to claim 20, wherein at least one of pixel electrodes in respective pixels which are juxtaposed in the direction of a scanning line is arranged to form a storage capacitance with at least one of said plurality of common lines which is associated thereto alternately different from pixel to pixel.

24. A liquid crystal display device having a pair of opposed substrates, at least one of which is transparent, a liquid crystal layer interposed between said pair of substrates, and an electrode structure formed on one of said pair of substrates, which electrode structure produces an electric field which is disposed predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements each formed at intersections of said matrix pattern;
a plurality of pixel electrodes each connected to a respective one of said plurality of active elements in a respective pixel;
a plurality of common lines each formed between an adjacent two of said plurality of scanning lines, respectively; and
a plurality of counter electrodes each formed opposing to each corresponding pixel electrode in each one of said plurality of pixels, each one of said plurality of counter electrodes of pixels juxtaposed in the direction of said scanning lines is connected to a same one of said plurality of common lines;
wherein charged pixels of said plurality of pixels juxtaposed in the direction of said scanning lines which have changed transmittance of light thereof due to an application of voltages to corresponding signal lines, scanning lines and common lines thereto are arranged in a staggered pattern on either side of the scanning lines corresponding thereto.

25. A liquid crystal display device according to claim 24, further comprising a drive unit for applying a voltage to said plurality of signal lines, said plurality of scanning lines and said plurality of common lines, wherein said drive unit:
applies two kinds of common voltages to said plurality of common lines alternately for every line;
interchanges said two kinds of common voltages in every frame writing cycle; and
supplies a liquid crystal application voltage to said plurality of signal lines by reversing the polarity of the voltage thereof for every line and for every one frame writing period of time, said liquid crystal application voltage including a voltage applied to one of said plurality of common lines corresponding thereto as a reference voltage thereof.

26. A liquid crystal display device according to claim 24, wherein at least one of pixel electrodes in respective pixels which are juxtaposed in the direction of a scanning line is arranged to form a storage capacitance with at least one of said plurality of common lines which is associated thereto alternately different from pixel to pixel.

27. A liquid crystal display device having a pair of opposed substrates, at least one of which is transparent, a liquid crystal layer interposed between said pair of substrates, and an electrode structure formed on one of said pair of substrates, which electrode structure produces an electric field which is predominantly in parallel with said pair of substrates, wherein said electrode structure comprises:
a plurality of scanning lines;
a plurality of signal lines formed in a matrix pattern with said plurality of scanning lines so that a plurality of pixels are formed in areas surrounded by said plurality of signal lines and said plurality of scanning lines, respectively;
a plurality of active elements formed in the vicinity of intersections of said matrix pattern;
a plurality of pixel electrodes each connected to a respective one of said plurality of active elements in a respective pixel; and
at least two common lines formed between any two signal lines of said plurality of signal lines so as to interpose each one of said plurality of pixel electrodes.

28. A liquid crystal display device according to claim 27, wherein said at least two common lines formed between two respective signal lines of said plurality of signal lines are connected to each other at least partially between said respective two signal lines corresponding thereto.

29. A liquid crystal display device comprising:
a liquid crystal layer supported between a pair of opposed substrates, each substrate having at least one transparent surface; and
an electrode arrangement formed on one of said pair of substrates, which electrode arrangement induces an electric field which is predominantly in parallel with said substrates, said electrode arrangement comprising:
a plurality of scanning lines;
a plurality of signal lines formed in a matrix pattern with said plurality of scanning lines so as to form a plurality of pixels; and
a plurality of pixel electrodes provided in said plurality of pixels, which pixel electrodes are connected to a plurality of active elements, respectively, formed at respective intersections between said plurality of signal lines and said plurality of scanning lines; wherein
each pixel electrode in a group of four juxtaposed pixels arranged horizontally and vertically a voltage applied thereto when no voltage is applied to other pixel electrodes juxtaposed thereto.

30. A liquid crystal display apparatus having a pair of substrates, at least one of which is transparent, and a liquid crystal layer interposed between said pair of substrates, one of said pair of substrates being provided with an electrode structure, wherein said electrode structure comprises:
a plurality of scanning lines;
a plurality of signal lines formed in a matrix pattern with said plurality of scanning lines;
a plurality of active elements each formed in the vicinity of intersections of said matrix pattern;
a plurality of pixel electrodes each connected to one of said plurality of active elements;
a plurality of common lines each formed between an adjacent two of said plurality of scanning lines;
a plurality of pixels being formed in areas surrounded by said plurality of signal lines and said plurality of scanning lines, respectively; and
a plurality of counter electrodes each formed opposing to each corresponding pixel electrode in each one of said plurality of pixels;
wherein each one of said plurality of active elements of said matrix pattern which is connected with each pixel electrode is connected to one of said plurality of scanning lines corresponding thereto which is different from each other between juxtaposed pixels in the direction of said scanning lines, and each one of said plurality of counter electrodes of pixels juxtaposed in the direction of said scanning lines is connected to a same one of said plurality of scanning line so that a current to be carried by a respective one of said plurality of common lines is reduced.

31. A liquid crystal display apparatus according to claim 30, further comprising a drive unit for applying a voltage to said plurality of signal lines, said plurality of scanning lines and said plurality of common lines, wherein said drive unit applies two different kinds of voltages to said plurality of common lines alternately for every line, interchanges said two different kinds of common line voltages for every one frame writing cycle, and applies a liquid crystal application voltage to said plurality of signal lines by reversing polarity of its voltage for every line and for every one frame writing cycle, said liquid crystal application voltage having a voltage applied to one of said plurality of common lines corresponding thereto as a reference voltage therefor.

32. A liquid crystal display apparatus having a pair of substrates, at least one of which is transparent, and a liquid crystal layer interposed between said pair of substrates, one of said pair of substrates having an electrode structure formed thereon, wherein said electrode structure comprises:
a plurality of scanning lines;
a plurality of signal lines formed in a matrix pattern with said plurality of scanning lines;
a plurality of active elements each formed at intersections of said matrix pattern;
a plurality of pixel electrodes each connected to one of said plurality of active elements;
a plurality of common lines each formed between an adjacent two of said plurality of scanning lines;
a plurality of pixels being formed in areas surrounded by said plurality of signal lines and said plurality of scanning lines; and
a plurality of counter electrodes each formed opposing to each corresponding pixel electrode in each one of said plurality of pixels, each one of said plurality of counter electrodes of pixels juxtaposed in the direction of said scanning lines is connected to a same one of said plurality of common lines corresponding thereto;
wherein charged pixels of said plurality of pixels juxtaposed in a direction of any one of said scanning lines which have changed transmittance of light thereof due to application of voltages to corresponding signal lines, scanning lines and common lines thereto are arranged in a staggered pattern along any one of said plurality of scanning lines corresponding thereto.

33. A liquid crystal display apparatus according to claim 32, having a drive unit for applying a voltage to said plurality of signal lines, said plurality of scanning lines and said plurality of common lines, wherein said drive unit applies two kinds of common voltages to said plurality of common lines alternately for every line, interchanges said two kinds of common voltages for every one frame writing cycle, and supplies a liquid crystal application voltage to said plurality of signal lines by reversing polarity of voltage thereof for every line and for every one frame writing period of time, said liquid crystal application voltage comprising a voltage applied to one of said plurality of common lines corresponding thereto as a reference voltage thereof.
